(19) United States
(12) Patent Application Publication
(10) Pub. No.: US 2026/0370512 A1
(43) Pub. Date: Nov. 19, 2026

(54) IN-VEHICLE NETWORK SYSTEM, CONTROL METHOD OF IN-VEHICLE NETWORK SYSTEM, A HIGH-LEVEL SIDE CONTROL DEVICE, AND PROGRAM

(71) Applicant: DENSO CORPORATION, Kariya-city (JP)

(72) Inventors: Sho MATSUMOTO, Kariya-shi (JP); Tomohisa KISHIGAMI, Kariya-shi (JP)

(21) Appl. No.: 19/655,020

(22) Filed: Apr. 22, 2026

(30) Foreign Application Priority Data
May 15, 2025 (JP) 2025-082170

(51) Int. Cl. H04L 12/40; H04L 67/12

(52) U.S. Cl. CPC H04L 12/40013; H04L 67/12; H04L 2012/40273

(57) ABSTRACT

In an in-vehicle network system, a high-level side control device controls supply of power to a target device. The high-level side control device includes: a relay controller that turns ON or OFF a relay circuit provided in a power supply line for the target device; a virtual communication node manager that manages a virtual communication node corresponding to the relay circuit; and a virtual relay that virtually relays a network management message to the virtual communication node manager when the high-level side control device receives the network management message. The virtual communication node manager commands the relay controller to turn ON the relay circuit when the received network management message commands the virtual communication node to activate.

### CROSS-REFERENCE TO RELATED APPLICATION

This application is based on Japanese Patent Application No. 2025-082170 filed in Japan on May 15, 2025. The entire disclosure of the above application is incorporated herein by reference.

### TECHNICAL FIELD

The present disclosure relates to an in-vehicle network system including a plurality of control devices connected to a communication bus and capable of communicating with each other in a vehicle and relates to a control method of an in-vehicle network system. The present disclosure also relates to a high-level side control device used in an in-vehicle network system to control supply and non-supply of power to at least one target device. Furthermore, the present disclosure relates to a program causing a high-level side control device to execute a process of controlling supply and non-supply of power to at least one target device.

### BACKGROUND

For example, there is such a technology that an in-vehicle device cuts off supply of power from a power supply device to an in-vehicle ECU not required to be activated. The technology activates only an activation-target in-vehicle ECU and avoids activating an in-vehicle ECU not required to be activated.

### SUMMARY

According to an aspect of the present disclosure, in an in-vehicle network system, a high-level side control device controls supply of power to a target device. The high-level side control device includes: a relay controller that turns ON or OFF a relay circuit provided in a power supply line for the target device; a virtual communication node manager that manages a virtual communication node corresponding to the relay circuit; and a virtual relay that virtually relays a network management message to the virtual communication node manager when the high-level side control device receives the network management message. The virtual communication node manager commands the relay controller to turn ON the relay circuit when the received network management message commands the virtual communication node to activate.

### BRIEF DESCRIPTION OF THE DRAWINGS

Objects, features and advantages of the present disclosure will become apparent from the following detailed description made with reference to the accompanying drawings.

FIG. 1 is a diagram showing an example of a configuration of an in-vehicle network system according to a first embodiment.

FIG. 2 is a diagram illustrating a configuration of a communication node in the in-vehicle network system of FIG. 1.

FIG. 3 is a diagram for describing an example of an NM message, PN request information, and PNC configuration information.

FIG. 4 is a flowchart showing an example of processes executed by a high-level ECU and first to third intermediate-level ECUs.

FIG. 5 is a flowchart showing an example of details of a virtual relay process in step S160 of the flowchart in FIG. 4.

FIG. 6 is a flowchart showing an example of a process performed in first to third virtual communication node managers.

FIG. 7 is a diagram showing an example of a configuration of an in-vehicle network system according to a second embodiment.

FIG. 8 is a flowchart showing an example of a process executed by a PNC configuration information manager.

FIG. 9 is a flowchart shows an example of details of a PNC configuring necessity determination process in step S440 of the flowchart in FIG. 8.

FIG. 10 is a flowchart showing an example of details of a configuration status determination process in step S650 of the flowchart in FIG. 9.

FIG. 11 is a sequence diagram showing an example of a flow of processes at execution of the configuration status determination process, the flow including processes by the PNC configuration information manager, and a real machine communication node and a virtual communication node in the high-level ECU.

FIG. 12 is a flowchart showing an example of details of a PNC configuring process in step S460 of the flowchart in FIG. 8.

FIG. 13 is a sequence diagram showing an example of a flow of processes at execution of the PNC configuring process, the flow including processes by the PNC configuration information manager, and a real machine communication node and a virtual communication node in the high-level ECU.

FIG. 14 is a flowchart showing an example of a process executed by the high-level ECU and the first to third intermediate-level ECUs.

FIG. 15 is a flowchart showing an example of details of a virtual relay process in step S161 of the flowchart in FIG. 14.

FIG. 16 is a flowchart showing an example of details of a PNC configuring response process in step S166 of the flowchart in FIG. 14.

FIG. 17 is a flowchart showing an example of details of a configuration status check process in step S167 of the flowchart in FIG. 14.

FIG. 18 is a flowchart showing an example of a process executed in first to third virtual communication node managers.

### DETAILED DESCRIPTION

For example, there is such a technology that an in-vehicle device cuts off supply of power from a power supply device to an in-vehicle ECU not required to be activated. The in-vehicle device is communicably connected to multiple in-vehicle ECUs. The in-vehicle device acquires information on an activation-target in-vehicle ECU via an in-vehicle network. Then, the in-vehicle device supplies power to the activation-target in-vehicle ECU and outputs an activation signal via the in-vehicle network while cutting off the supply of power to the in-vehicle ECU that is not required to be activated. This results in activating only the activation-target in-vehicle ECU by the activation signal, and avoiding activating the in-vehicle ECU not required to be activated.

In the above technology, a respective in-vehicle ECU is configured to transition to a wake-up state (activated state) or a sleep state (stop state or standby state) by receiving a wake-up signal or a sleep signal transmitted from the in-vehicle device. Furthermore, the in-vehicle device is configured to supply power to the respective in-vehicle ECU and cut off the supply of power to the respective in-vehicle ECU by executing and stopping application of a gate voltage to a gate terminal of a semiconductor relay such as a FET.

Therefore, in the above technology, it is necessary that the in-vehicle device determine whether to output a signal (gate drive signal) for supplying power to a respective in-vehicle ECU and determine whether to output a signal (wake-up signal or sleep signal) for switching over a respective in-vehicle ECU between the wake-up state and the sleep state. Furthermore, it is necessary that, based on results of the determinations, the in-vehicle device separately output the gate signal and the wakeup signal (or the sleep signal).

It is an object of the present disclosure to provide an in-vehicle network system and a control method of an in-vehicle network system that can control supply of power to a target device in a simpler manner. It is also an object of the present disclosure to provide a high-level side control device used in an in-vehicle network system to control supply of power to a target device. It is also an object of the present disclosure to provide a program that causes a high-level side control device to execute a process of controlling supply of power to a target device.

According to a first aspect of the present disclosure, an in-vehicle network system comprising a plurality of control devices communicable with each other via a communication bus in a vehicle is provided. The plurality of control devices includes a high-level side control device. The high-level side control device controls supply and non-supply of power to a target device. The high-level side control device includes: a relay controller (16, 26) that turns ON or OFF a relay circuit provided in a power supply line for the target device; a virtual communication node manager that manages a virtual communication node corresponding to the relay circuit; and a virtual relay that virtually relays a network management message to the virtual communication node manager when the high-level side control device receives the network management message. The virtual communication node manager commands the relay controller to turn ON the relay circuit when the received network management message commands the virtual communication node to activate.

According to a second aspect of the present disclosure, a high-level side control device that is used in an in-vehicle network system including a plurality of control devices communicable with each other via a communication bus in a vehicle is provided. The high-level side control device controls supply and non-supply of power to a target device. The high-level side control device comprises: a relay controller that turns ON or OFF a relay circuit provided in a power supply line for the target device; a virtual communication node manager that manages a virtual communication node corresponding to a relay circuit; and a virtual relay that virtually relays a network management message to the virtual communication node manager when the high-level side control device receives the network management message. The virtual communication node manager commands the relay controller to turn ON the relay circuit when the received network management message commands the virtual communication node to activate.

According to a third aspect of the present disclosure, a program for a high-level side control device that is used in an in-vehicle network system including a plurality of control devices communicable with each other via a communication bus in a vehicle is provided. The program causes the high-level side control device to execute controlling supply and non-supply of power to a target device and causes the high-level side control device to function as: a relay controller that turns ON or OFF a relay circuit provided in a power supply line for the target device; a virtual communication node manager that manages a virtual communication node corresponding to a relay circuit; and a virtual relay that virtually relays a network management message to the virtual communication node manager when the high-level side control device receives the network management message. The virtual communication node manager commands the relay controller to turn ON the relay circuit when the received network management message commands the virtual communication node to activate.

According to a fourth of the present disclosure, a control method of an in-vehicle network system including a plurality of control devices communicable with each other via a communication bus in a vehicle is provided. The plurality of control devices includes a high-level side control device that controls supply and non-supply of power to a target device by turning ON and OFF a relay circuit provided in a power supply line for the target device. The high-level side control device includes a virtual communication node manager that manage a virtual communication node corresponding to the relay circuit. The control method comprises: virtually relaying a network management message to the virtual communication node manager when the high-level side control device receives the network management message; and commanding, by the virtual communication node manager, turn ON of the relay circuit when the received network management message commands the virtual communication node to activate.

In the in-vehicle network system, the control method of the in-vehicle network system, and the high-level side control device, and the program, the high-level side control device can supply the power to the target device according to the network management message commanding the virtual communication node to activate. Therefore, it is possible to control supply of power to the target device in a simple manner.

Embodiments of an in-vehicle network system, a control method of the in-vehicle network system, a high-level side control device, and a program in the present disclosure will be described with reference to the drawings. The present disclosure is not limited to the following embodiments, and various modifications including those described below are also included in the spirit and scope of the present disclosure. Embodiments and various modification examples are combinable as appropriate to extents that do not cause technical contradictions. In the following, like references are used to refer to like parts to simplify the description. When only part of the configuration is described, the description given elsewhere can be applied to the rest of the configuration.

### FIRST EMBODIMENT

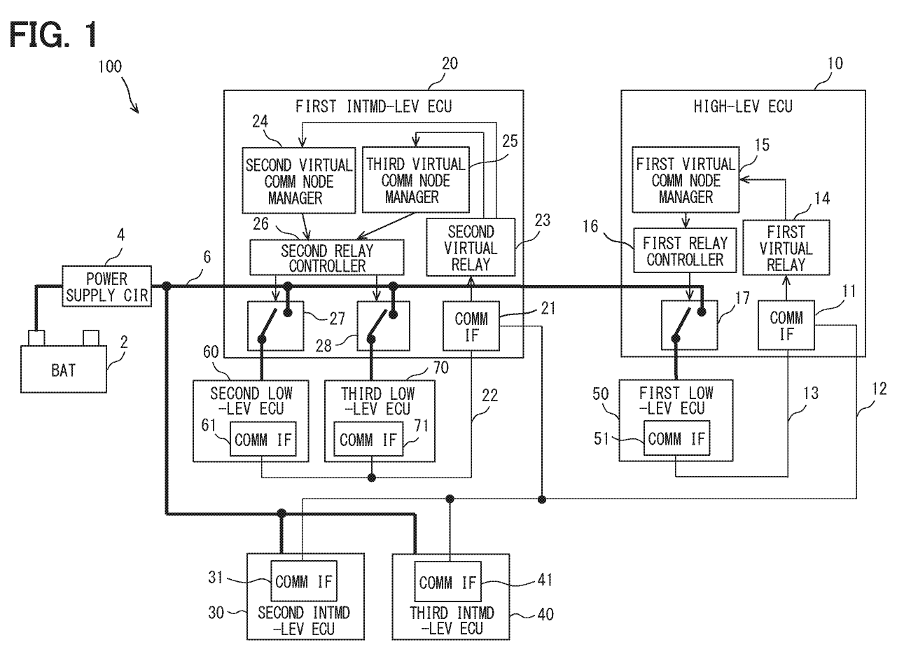

FIG. 1 is a diagram showing a configuration example of an in-vehicle network system 100 according to the present embodiment. The in-vehicle network system 100 shown in FIG. 1 includes a high-level ECU 10, first to third intermediate-level ECUs 20, 30, 40, and first to third low-level ECUs 50, 60, 70. ECU is an abbreviation for Electronic Control Unit. In the present embodiment, the high-level ECU 10, the first to third intermediate-level ECUs 20, 30, 40, and the first to third low-level ECUs 50, 60, 70 are mounted on a vehicle. The vehicle encompasses a passenger car, a motorcycle, a transport vehicle, a construction vehicle, an agricultural vehicle, and the like.

The in-vehicle network system 100 operates with the power supplied from a battery 2 mounted on the vehicle. More specifically, the power from the battery 2 is provided via the power circuit 4 to the high-level ECU 10, the first to third intermediate-level ECUs 20, 30, 40, and the first to third low-level ECUs 50, 60, 70 of the in-vehicle network system 100. The power circuit 4 is able to convert the supply voltage of the battery 2 mounted on the vehicle into an operating voltage of the high-level ECU 10, the first to third intermediate-level ECUs 20, 30, 40, and the first to third low-level ECUs 50, 60, 70, as needed.

Relay circuits 17, 27, 28 are provided in power supply lines 6 for the first to third low-level ECUs 50, 60, 70. The first to third relay circuits 17, 27, 28 are switched over between an ON state and an OFF state by a first relay controller 16 of the high-level ECU 10 and a second relay controller 26 of the first intermediate level ECU 20. The high-level ECU 10 and the first intermediate-level ECU 20 correspond to a high-level side control device of the present disclosure. The first to third low-level ECUs 50, 60, 70 correspond to target devices of the present disclosure.

The first to third relay circuit 17, 27, 28 may be provided by a semiconductor switch, such as a metal oxide semiconductor field effect transistor (MOSFET), an insulated gate bipolar transistor (IGBT), etc. Alternatively, the first to third relay circuit 17, 27, 28 may be provided by a normal mechanical relay instead of the semiconductor switch. The first to third relay circuits 17, 27, 28 may be arranged inside the high-level ECU 10 and the first intermediate-level ECU 20 as shown in FIG. 1 or may be arranged outside the high-level ECU 10 and the first intermediate-level ECU 20.

The configuration of the in-vehicle network system 100 is not limited to the example shown in FIG. 1. For example, the number of high-level ECUs 10 may be two or more instead of one. In this case, an intermediate-level ECU and a low-level ECU may be arranged below a respective high-level ECU. Two or more high-level ECUs may be communicably connected to each other. One of the intermediate-level ECUs 20, 30, 40 may be configured to perform the functions of the high-level ECU 10, and the high-level ECU 10 may be omitted. The number of intermediate-level ECUs 20, 30, 40 arranged below the high-level ECU 10 may be other than three, that is, may be two or less, or four or more. Regarding the low-level ECUs 50, 60, 70, multiple low-level ECUs may be connected to one relay circuit 17, 27, 28. The low-level ECUs 50, 60, 70 may include a low-level ECU configured to be supplied with the power directly from the power supply circuit 4 without going through the relay circuits 17, 27, 28. Furthermore, a target device connected to the relay circuit 17, 27, 28 is not limited to the low-level ECU and may be a sensor or an actuator.

The high-level ECU 10, the first to third intermediate-level ECUs 20, 30, 40, and the first to third low-level ECUs 50, 60, 70 may each include a computer, including a processor, a memory, and a storage. Examples of the processor include a CPU (Central Processing Unit), an MPU (Micro Processing Unit), a GPU (Graphics Processing Unit), and a DFP (Data Flow Processor), which are capable of executing a given process according to a program. The memory includes a volatile storage medium, such as a RAM (Random Access Memory), which temporarily stores results of computational processing executed by the processor. The storage includes non-volatile storage medium such as a flash memory, a ROM (Read Only Memory), etc. The storage stores various data and programs to be executed by the processor.

The high-level ECU 10, the first to third intermediate-level ECUs 20, 30, 40, and the first to third low-level ECUs 50, 60, 70, respectively, include communication interfaces (communication IF) 11, 21, 31, 41, 51, 61, 71 for communication with other ECUs via communication buses 12, 13, 22.

The communication IF 11 of the high-level ECU 10 is connected to the communication IFs 21, 31, 41 of the first and third intermediate-level ECUs 20, 30, 40 via the communication bus 12. The first and third intermediate-level ECUs 20, 30, 40 can also communicate with each other via this communication bus 12. However, the communication bus connecting the high-level ECU 10 to the first to third intermediate-level ECUs 20, 30, 40 may be provided separately from the communication bus connecting the first to third intermediate-level ECUs 20, 30, 40 to each other.

The communication IF 11 of the high-level ECU 10 is connected to the communication IF 51 of the first low-level ECU 50 via the communication bus 13. The communication IF 21 of the first intermediate-level ECU 20 is connected to the communication IF 61 of the second low-level ECU 60 and the communication IF 71 of the third low-level ECU 70 via the communication bus 22. The communication IF 61 of the second low-level ECU 60 and the communication IF 71 of the third low-level ECU 70 may be connected to the communication IF 21 of the first intermediate-level ECU 20 via separate communication buses.

The in-vehicle network system 100 may use CAN as a communication protocol for the communication IFs 11, 21, 31, 41, 51, 61, 71 of the high-level ECUs 10, the first to third intermediate-level ECUs 20, 30, 40, and the first to third low-level ECUs 50, 60, 70 to communicate with each other. CAN is an abbreviation for Controller Area Network. However, the communication protocol is not limited to CAN, and the in-vehicle network system 100 may employ a variety of communication protocols such as Ethernet (registered trademark), LIN (Local Interconnect Network), FlexRay (registered trademark), CAN-FD (CAN with Flexible Data Rate (CAN with Flexible Data Rate), etc. For example, different communication protocols may be employed for different communication buses 12, 13, 22.

The high-level ECU 10 may, for example, function as a domain controller that supervises control of the first to third intermediate-level ECUs 20, 30, 40, and the first to third low-level ECUs 50, 60, 70. Domains refers to units of functions when vehicle functions are broadly divided into, for example, a powertrain domain, a chassis domain, an advanced driver assistance domain, a body domain, a cockpit domain, and the like. For example, when the domain controller of the powertrain domain is the high-level ECU 10, the first to third intermediate-level ECUs 20, 30, 40 and the first to third low-level ECUs 50, 60, 70 include ECUs for controlling the powertrain of the vehicle, such as an engine ECU, a motor (inverter) ECU, a battery monitoring ECU, a transmission ECU, etc. When the domain controller of the body domain is the high-level ECU 10, the first to third intermediate-level ECUs 20, 30, 40 and first to third low-level ECUs 50, 60, 70 include ECUs for vehicle body control, such as a collation ECUs, a door ECUs, a window ECU, a camera ECU, etc.

The above is an example of how to divide into domains. The domains may be different from those in the above-described example. Alternatively, the high-level ECU 10 may function as an area controller arranged for each area of the vehicle (e.g., front area, rear area, right area, left area, etc.) to supervise control of the first to third intermediate-level ECUs 20, 30, 40, and first to third low-level ECUs 50, 60, 70 arranged in the each area.

The high-level ECU 10, for example, acts as a domain controller and, based on various types of information such as various sensor signals, switch signals, signals acquired from other ECUs, etc., determines that the situation of the vehicle requires the first to third intermediate-level ECU 20, 30, 40, the first to third low-level ECU 50, 60, 70, etc. to be activated and operate. If the high-level ECU 10 determines that the situation requires at least one of the ECU 20, 30, 40, 50, 60, 70 to be activated and operate, the high-level ECU 10 may activate and put the corresponding ECU 20, 30, 40, 50, 60, 70 in an operational state, by transmitting a network management (also referred to as "NM") message. NM messages will be described in detail later.

In addition to or in place of the high-level ECU 10, another ECU such as the first to third intermediate-level ECU 20, 30, 40, etc., may have the function of determining that the situation requires at least one of: the first to third intermediate-level ECUs 20, 30, 40; and the first to third low-level ECUs 50, 60, 70 to be activated and operate and transmitting the NM message. Furthermore, in the vehicle including the plurality of high-level ECUs, when at least one intermediate-level ECU is arranged as a subordinate of a respective high-level ECU, another high-level ECU or an intermediate-level ECU arranged as a subordinate of another high-level ECU may transmit the NM message to activate at least one of: the first to third intermediate-level ECUs 20, 30, 40; and the first to third low-level ECUs 50, 60, 70.

In the in-vehicle network system 100 of the present embodiment, as shown in FIG. 1, the first to third relay circuits 17, 27, 28 are provided in the respective power supply lines 6 for the first to third low-level ECUs 50, 60, 70. Therefore, to put the first to third low-level ECUs 50, 60, 70 into the operational state, it is necessary to turn ON the corresponding first to third relay circuits 17, 27, 28.

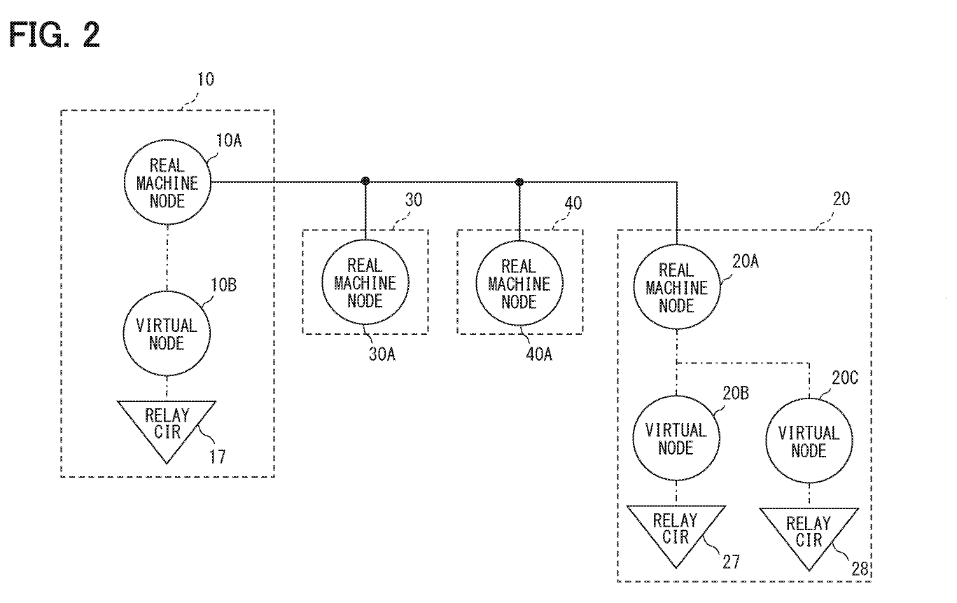

In the present embodiment, in order to enable the ON state and the OFF state of the first to third relay circuits 17, 27, 28 to be controlled by NM messages, virtual communication nodes are provided to correspond to the first to third relay circuits 17, 27, 28. A communication node means a communication entity that has a function of communication with another communication node, such as the high-level ECU 10, the first or third intermediate-level ECU 20, 30, 40, etc. For example, in the configuration shown in FIG. 1, the first virtual communication node 10B is provided as corresponding to the first relay circuit 17, as shown in FIG. 2. The second virtual communication node 20B is provided as corresponding to the second relay circuit 27, and the third virtual communication node 20C is provided as corresponding to the third relay circuit 28. As a result, as shown in FIG. 2, the high-level ECU 10 itself acts as a real machine communication node 10A, and additionally, the high-level ECU 10 includes a first virtual communication node 10B. The first intermediate-level ECU 20 itself acts as a real machine communication node 20A, and additionally, the first intermediate-level ECU 20 includes second and third virtual communication nodes 20B and 20C. The second and third intermediate-level ECUs 30 and 40 act as real machine communication nodes 30A and 40A.

In the present embodiment, the first to third virtual communication node managers 15, 24, 25 managing the first to third virtual communication nodes 10B, 20B, 20C are provided in the high-level ECU 10 and the first intermediate-level ECU 20 serving as the high-level side control devices. Specifically, the first virtual communication node manager 15 managing the first virtual communication node 10B is provided in the high-level ECU 10. The second virtual communication node manager 24 managing the second virtual communication node 20B is provided in the first intermediate-level ECU 20. Furthermore, the third virtual communication node manager 25 managing the third virtual communication node 20C is provided in the first intermediate-level ECU 20.

The high-level ECU 10 and the first intermediate-level ECU 20 include virtual relays 14, 23 that, upon receiving messages, e.g., NM messages, virtually relay the messages to the first to third virtual communication node managers 15, 24, 25. “Virtually relay" means that the first and second virtual relays 14, 23 hand over messages to the first and third virtual communication node managers 15, 24, 25, wherein the messages are messages received at the communication IF 11 of the high-level ECU 10 and the communication IF 21 of the first intermediate-level ECU 20 and destined for the virtual communication nodes 10B, 20B, 20C. The NM message is received by all communication nodes, including the virtual communication nodes 10B, 20B, 20C. Furthermore, when the first to third virtual communication node managers 15, 24, 25 transmit messages, e.g., NM messages, the first and second virtual relays 14, 23 virtually relay the messages to the communication IFs 11, 21 so that the messages are transmitted from the communication IF 11 of the high-level ECU and the communication IF 21 of the first intermediate-level ECU 20.

For each of all communication nodes including virtual communication nodes 10B, 20B, 20C, a respective communication node stores cluster configuration information (also called PNC configuration information) indicative of a cluster to which the respective communication node belongs. For example, the PNC configuration information indicative of the cluster to which a respective virtual communication node 10B, 20B, 20C belongs is stored in the corresponding first to third virtual communication node manager 15, 24, 25. The NM message contains active cluster information (also called PN request information) designating an active cluster being a cluster to be active.

The first to third virtual communication node manager 15, 24, 25 receives the NM message virtually relayed by the first and second virtual relay 14, 23, as described above. When the active cluster designated in the PN request information of the received NM message matches the cluster of the stored cluster configuration information of the virtual communication node 10B, 20B, 20C, the first and third virtual communication node manager 15, 24, 25 considers that the corresponding virtual communication node 10B, 20B, 20C is commanded to activate by the NM message. When the received NM message commands the virtual communication node 10B, 20B, 20C to activate, the first to third virtual communication node manager 15, 24, 25 commands the first, second relay controller 16, 26 to turn ON the corresponding first to third relay circuit 17, 27, 28. In this way, turn ON and OFF of the first to third relay circuit 17, 27, 28 is controlled by the NM message in the in-vehicle network system 100. The cluster configuration information (PNC configuration information) and the active cluster information (PN request information) will be described in detail later.

The PNC configuration information stored in the first to third virtual communication node manager 15, 24, 25 may be determined based on the PNC configuration information of the first to third low-level ECU 50, 60, 70 connected to the first to third relay circuit 17, 27, 28. For example, as shown in FIG. 1, when only one target device being one of the first to third low-level ECUs 50, 60, 70 is connected to one relay circuit being one of the first to third relay circuits 17, 27, 28, the PNC configuration information stored in the first to third virtual communication node manager 15, 24, 25 may include the PNC configuration information of the connected low-level ECU being one of the first to third low-level ECUs 50, 60, 70. In this case, the PNC configuration information stored in each one of the first to third virtual communication node managers 15, 24, 25 may be the same as the PNC configuration information of the connected low level ECU being one of the first to third low-level ECUs 50, 60, 70. This allows the first to third virtual communication node managers 15, 24, 25 to turn ON the corresponding first to third relay circuits 17, 27, 28 in response to the NM messages commanding the connected first to third low-level ECUs 50, 60, 70 to activate.

When a plurality of low-level ECUs are connected to at least one relay circuit of the first to third relay circuits 17, 27, 28, the PNC configuration information stored in the virtual communication node manager corresponding to the at least one relay circuit to which the plurality of low-level ECUs (e.g., the first low-level ECU and the second low-level ECU) are connected may include PNC configuration information corresponding to logical OR of the plurality of PNC configuration information of the plurality of low-level ECUs (e.g., the logical OR of the PNC configuration information of the first low-level ECU and the PNC configuration information of the second low-level ECU). In this case, the PNC configuration information stored in the virtual communication node manager may be the same as the PNC configuration information corresponding to the logical OR of the plurality of cluster configuration information of the plurality of low-level ECUs. Because of this, it is possible to turn ON the relay circuit to which the plurality of low-level ECUs are connected in response to the NM message commanding any (any one or ones) of the plurality of low-level ECUs to activate.

The target device connected to at least one of the first to third relay circuits 17, 27, 28 may not be the low-level ECU but may be a sensor and/or an actuator. This allows the power to be supplied to the sensor and/or the actuator only when the sensor and/or the actuator is required to operate. The sensor and/or the actuator may be a smart sensor and/or a smart actuator having a communication function of communicating with another ECU via the communication bus 12, 13, 22. If the sensor and/or the actuator has the communication function, the PNC configuration information is determined for the sensor and/or the actuator so that the sensor and/or the actuator is activatable by the NM message.

The sensor and/or the actuator may not have the communication function of communicating via the communication bus 12, 13, 22 and may be connected only to an ECU to which a sensor signal is input and/or an ECU which outputs an actuator drive signal. In this case, the PNC configuration information is not determined for the sensor and/or the actuator. Therefore, it is not possible that the PNC configuration information to be stored in the first to third virtual communication node manager 15, 24, 25 is determined based on the PNC configuration information of the sensor and/or the actuator connected to the first to third relay circuit 17, 27, 28.

In such a situation, the PNC configuration information stored in the first and third virtual communication node manager 15, 24, 25 may be determined so that the sensors and/or the actuator is activated by NM messages in response to an occurrence of a situation that requires the sensor and/or the actuator to operate. For example, the first to third virtual communication node manager 15, 24, 25 may store the PNC configuration information including the PNC configuration information of the ECU to which the sensor signal is input and/or the PNC configuration information of the ECU which outputs the actuator drive signal. Because of this, it is possible to turn ON the relay circuit connected to the sensor and/or the actuator and supply the power to the sensor and/or actuator when the ECU to which the sensor signal is input and/or the ECU which outputs the actuator drive signal is activated by the NM message. According to the present embodiment described above, even if the target device connected to the first or third relay circuit 17, 27, or 28 does not have (retain) the PNC configuration information, it is possible to timely supply the power to the target device by turning ON the relay circuit according to the NM message.

As described above, the high-level ECU 10 and the first intermediate-level ECU 20 include the first relay controller 16 and the second relay controller 26 to control the ON state and the OFF state of the first to third relay circuits 17, 27, 28. The first relay controller 16 and the second relay controller 26 are functions of the high-level ECU 10 and the first intermediate-level ECU 20. The first relay controller 16 turns ON or OFF the first relay circuit 17 based on the command from the first virtual communication node manager 15. The second relay controller 26 turns ON or OFF the second relay circuit 27 based on the command from the second virtual communication node manager 24. In addition, the second relay controller 26 turns ON or OFF the third relay circuit 28 based on the command from the third virtual communication node manager 25.

In addition to the function of turning ON and OFF the first to third relay circuit 17, 27, 28, the high-level ECU 10 and the first intermediate-level ECU 20 also function as relay devices for bidirectional communication between the ECUs connected to different communication buses 12, 13, 22. For example, the high-level ECU 10 and the first intermediate-level ECU 20 function as gateways for a NM message received from one communication bus 12, 13, 22 to another communication bus 12, 13, 22. In the above, if the communication protocol is different between the communication bus from which the NM message is received and the communication bus to which the NM message is transmitted, the high-level ECU 10 and the first-intermediate-level ECU 20 further perform protocol conversion. In the in-vehicle network system 100, for example, in addition to NM messages for partial networking between the first to third intermediate-level ECUs 20, 30, 40 and the first to third low-level ECUs 50, 60, 70, control messages containing data on control are also exchanged. The high-level ECU 10 and the first intermediate-level ECU 20 also serve as gateways for such control messages. This enables smooth execution of coordinated control by multiple ECUs belonging to the same cluster.

The first to third intermediate-level ECUs 20, 30, 40, and the first to third low-level ECUs 40, 50, 60 may include, for example, a control ECU that executes a control process of controlling a given control object in a vehicle, a sensor ECU that calculates a given physical quantity based on a detection signal detected by a sensor, and a drive ECU that outputs a drive signal to an actuator to drive the actuator. The first to third low-level ECU 50, 60, 70 activates and enters into the operational state when the corresponding first to third relay circuit 17, 27, 28 is turned ON by the high-level ECU 10 or the first intermediate-level ECU 20. The first to third low-level ECU 50, 60, 70 having entered into the operational state executes a given process, e.g., a control process for controlling a control target, a calculation process for calculating a given physical quantity based on a detection signal of the sensor, and a drive process for outputting a drive signal to drive the actuator.

Each one of: the first to third intermediate-level ECU 20, 30, 40; and the first to third low-level ECUs 40, 50, 60 stores the PNC configuration information indicating the cluster to which the each one belongs among multiple clusters being multiple divisions. For example, the PNC configuration information is stored in the nonvolatile storage medium of each one: of the first to third intermediate-level ECUs 20, 30, 40; and the first to third low-level ECUs 50, 60, 70. While a respective ECU is executing the control process, the calculation process, or the drive process, etc., the respective ECU periodically transmits the NM message containing the active cluster information (called the PN request information) that designates the cluster to which the respective ECU belongs as the active cluster, wherein the respective ECU is any of: the first to third intermediate-level ECUs 20, 30, 40; and the first to third low-level ECUs 40, 50, 60. The PN request information will be described in details later. When the execution of the control process, the calculation process, or the drive process, etc., is completed, the respective ECU being any of; the first to third intermediate-level ECUs 20, 30, 40; and the first to third low-level ECUs 40, 50, 60 stop transmitting the NM message. A respective communication node manager being any of the first to third virtual communication node managers 15, 24, 25 may also periodically transmit the NM message containing the PN request information designating the cluster to which the respective communication node manager belong as the active cluster if necessary, while the corresponding first to third relay circuit 17, 27, 28 is in the ON state.

The respective ECU being any of: the first to third intermediate-level ECUs 20, 30, 40; and the first to third low-level ECUs 50, 60, 70 transitions to the sleep state upon: completing the calculation process, or the drive process, etc.,; and elapse of a given period of time since the last receipt of the NM message designating the cluster to which the respective ECU belongs as the active cluster. The elapse of the given period of time can be rephrased such that a period of time during which the NM message designating the cluster to which the respective ECU belongs as the active cluster has not been received reaches the given period of time. A respective virtual communication node being any of the first to third virtual communication node managers 15, 24, 25 turns OFF the corresponding first to third relay circuit 17, 27, 28 if a period of time during which the NM message designating the cluster to which the respective virtual communication node belongs as the active cluster has not been received reaches a given period of time. As a result, the first to third intermediate-level ECU 20, 30, 40 and the first to third low-level ECU 50, 60, 70 that belong to the same cluster transition from the operational state to the sleep state or to the power supply stopped state at approximately the same time. In the sleep state, the first to third intermediate-level ECU 20, 30, 40 enters into a low power consumption state in which only a function of receiving the NM message is operational and other functions are stopped.

In order to receive NM messages in the sleep state, the first and third intermediate-level ECUs 20, 30, 40 include the communication IFs 21, 31, 41 supporting partial networking. For example, based on the PNC configuration information stored in the nonvolatile storage medium, a respective intermediate-level ECU being any of the first to third intermediate-level ECU 20, 30, 40 configures a respective corresponding communication IF 21, 31, 41 so that the respective corresponding communication IF 21, 31, 41 has information of the cluster to which the respective ECU 20, 30, 40 belongs as an activation condition. Thus, the respective communication IF 21, 31, 41 is able to determine whether or not the received NM message contains the PN request information that matches the cluster to which the corresponding first to third intermediate level ECU 20, 30, 40 belongs.

When the respective communication IF 21, 31, 41 determines that the received NM message contains the PN request information that matches the cluster to which the corresponding first to third intermediate-level ECU 20, 30, 40 belongs, the respective communication IF 21, 31, 41 activates and puts the corresponding first to third intermediate-level ECU 20, 30, 40 into the operational state. On the other hand, if the respective communication IF 21, 31, 41 determines that the received NM message does not contain the PN request information that matches the cluster to which the corresponding first to third intermediate-level ECU 20, 30, 40 belongs, the respective communication IF 21, 31, 41 keeps the sleep state of the corresponding first to third intermediate-level ECU 20, 30, 40.

The first to third intermediate-level ECU 20, 30, 40 may not include the communication IF 21, 31, 41 supporting the partial networking. In this case, when a respective communication IF 21, 31, 41 receives the NM message in a state where the corresponding first to third intermediate-level ECU 20, 30, 40 is in the sleep state, the respective communication IF 21, 31, 41 activates the corresponding first to third intermediate-level ECU 20, 30, 40. Then, the activated intermediate-level ECU 20, 30, 40 may determine whether or not the NM message contains the PN request information that matches the cluster to which the activated intermediate-level ECU 20, 30, 40 belongs. If the activated intermediate-level ECUs 20, 30, 40 determines that the NM message contains the PN request information that matches the cluster to which the activated intermediate-level ECUs 20, 30, 40 belongs, the activated intermediate-level ECU 20, 30, 40 keeps the operational state thereof. On the other hand, if the activated intermediate-level ECUs 20, 30, 40 determines that the NM message does not contain the PN request information that matches the cluster to which the activated intermediate-level ECUs 20, 30, 40 belongs, the activated intermediate-level ECU returns into the sleep state.

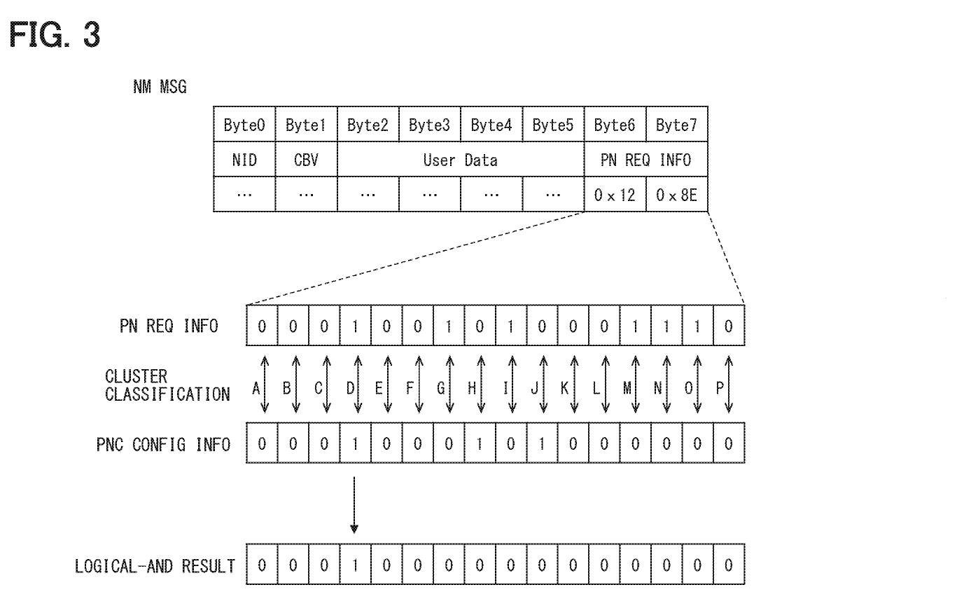

Next, the NM message, the PNC configuration information, and the PN request information will be described. FIG. 3 shows an example of the NM message. In the example shown in FIG. 3, the NM message contains data of Byte 0 to Byte 7. Byte 0 contains a node ID (NID). The node ID is a unique identifier for each of the communication nodes, wherein the communication nodes are the high-level ECU 10, the first to third intermediate-level ECUs 20, 30, 40, the first to third low-level ECUs 50, 60, 70, and the first to third virtual communication nodes 10B, 20B, 20C. Each communication node transmits and receives messages while using the node IDs to indicate a destination (transmission destination) and/or a source (a transmission source). For example, the high-level ECU 10 is the real machine communication node 10A, and a first node ID is determined for (assigned to) this real machine communication node 10A. A second node ID different from the first node ID is determined for (assigned to) the virtual communication node 10B implemented in the high-level ECU 10. The first node ID corresponds to a first node identifier of the present disclosure, and the second node ID corresponds to a second node identifier of the present disclosure. Byte 1 contains control bit vector (CBV). The control bit vector contains data indicating use or non-use of partial networking. When the control bit vector indicates the use of partial networking, the user data area of Byte 2 to Byte 7 contains the PN request information indicative of the cluster to be active.

In the example shown in FIG. 3, the control bit vector indicates the use of partial networking, and the PN request information is stored in Byte 6 and Byte 7 of the user data area. The user data area of Byte 2 to Byte 5 is usable to convey any information such as an activation factor of ECU, information on normality or abnormality, etc., for example. It should be noted that FIG. 3 shows only one example of the format of NM message. The NM message may be in another format as long as the NM message contains the PN request information. For example, the CBV may be omitted.

The PN request information indicates, for each of multiple clusters, whether the cluster is to be active or not required to be active. More specifically, in the example shown in FIG. 3, there are 16 clusters into which dividing was made in advance. The PN request information includes 16 bits data corresponding to the 16 clusters. The 16-bit data of the PN request information is associated with the 16 clusters in advance. When a bit of the 16 bits data in the PN request information is "0", it indicates that the associated cluster is not required to be active. When a bit of the 16 bits data in the PN request information is "1", it indicates that the associated cluster is required to be active. The PN request information may indicate only the cluster to be active (also referred to as the active cluster). Alternatively, the PN request information may indicate only the cluster not required to be active. Both of the PN request information indicating only the cluster to be active and the PN request information indicating only the cluster not required to be active is the PN request information explicitly or implicitly designating the cluster to be active. Both of the PN request information indicating only the cluster to be active and the PN request information indicating only the cluster not required to be active is the PN request information explicitly or implicitly designating the cluster not required to be active (also called de-active cluster).

FIG. 3 also shows an example of the PNC configuration information configured for the first to third intermediate-level ECU 20, 30, 40, the first to third low-level ECU 50, 60, 70, and the first to third virtual communication node 10B, 20B, 20C. In the PNC configuration information shown in FIG. 3, when the associated clusters are classified into A to P from the left to the right of the drawing, the PNC configuration information in FIG. 3 indicates that the ECU, etc., for which this PNC configuration information is configured belongs to the clusters D, H and J. Since the ECU, etc., can perform various functions by executing programs, the ECU, etc., may belong to one or more clusters.

The first to third intermediate-level ECUs 20, 30, 40, the first to third low-level ECUs 50, 60, 70, and the first to third virtual communication node 10B, 20B, 20C are each configured to receive the NM message containing the PN request information. Upon receiving the NM message, the communication IF 21, 31, 41, 51, 61, 71 and the first to third virtual communication node manager 15, 24, 25 each determine whether or not there is a match between the cluster requested to be active by the PN request information in the NM message and the cluster in the PNC configuration information configured for the each. For example, as shown in FIG. 3, for the cluster match determination, a bit-by-bit comparison between the PN request information in the NM message and the PNC configuration information is made to calculate the logical AND.

For example, in the example shown in FIG. 3, the clusters requested to be active by the PN request information are clusters D, G, I, M, N, and O. The clusters indicated by the PNC configuration information are clusters D, H, and J. In this case, at the cluster D, there is the match between the cluster requested to be active by the PN request information of the NM message and the cluster in the PNC configuration information. Therefore, the result of the logical AND is “1” at the cluster D as shown in FIG. 3.

When the logical AND results in “1 at any of the bits, the communication IF of the ECU or the first to third virtual communication node manager 15, 24, 25, for which the PNC configuration information shown in FIG. 3 is configured, determines that activation is requested (commanded) by the NM message. Upon this determination result, the communication IF activates the corresponding ECU and puts the corresponding ECU into the operational state or the first to third virtual communication node manager 15, 24, 25 turns ON the corresponding first to third relay circuit 17, 27, 28. If the ECU is already in the operational state, the ECU keeps the operational state. If the first to third relay circuit 17, 27, 28 is already in the ON state, the ON state of the first to third relay circuit 17, 27, 28 is kept.

When the logical AND results in “1” at none of the bits, in other words, results in “0” at all of the bits, the communication IF or the first to third virtual communication node manager 15, 24, 25 determines that the activation is not requested by the NM message. In this case, the communication IF does not activate the corresponding ECU and keeps it in the sleep state. If the ECU is in the operational state, the ECU continues counting the period of time during which the NM message requesting the activation has not been received. When the ECU has completed the given control process, etc., and the period of time during which the NM message requesting the activation has not been received reaches a given period of time, the ECU transitions from the operational state to the sleep state. The first to third virtual communication node manager 15, 24, 25 keeps the OFF state of the corresponding first to third relay circuits 17, 27, 28. If the corresponding first or third relay circuit 17, 27, 28 is in the ON state, counting the period of time during which the NM message requesting the activation has not been received continues. When the period of time during which the NM message requesting the activation has not been received reaches a given period of time, the first to third virtual communication node manager 15, 24, 25 turn OFF the corresponding first to third relay circuit 17, 27, 28. The PNC configuration information may also be configured for the high-level ECU 10 so that the high-level ECU is switched over between the operational state and the sleep states by the NM message.

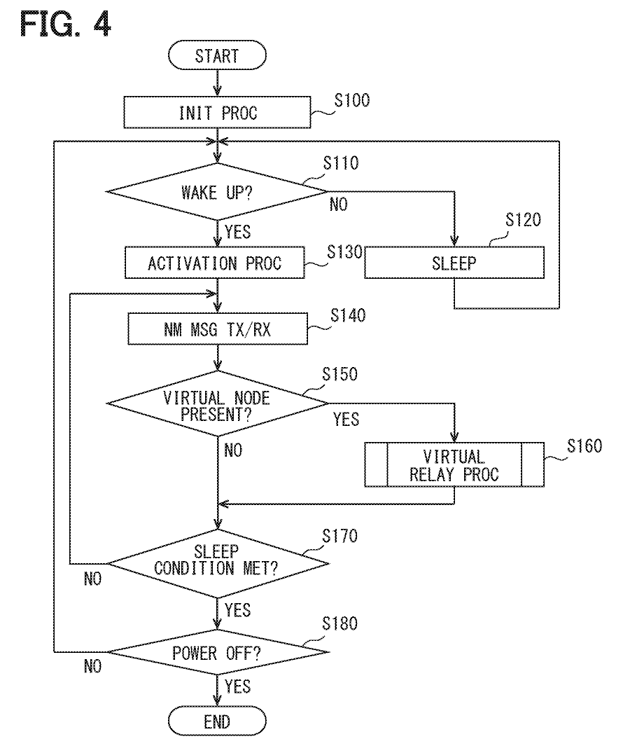

Next, processes executed for controlling the ON and OFF states of the first and third relay circuits 17, 27, 28 by the first and third virtual communication nodes 10B, 20B, 20C in the in-vehicle network system 100 will be described with reference to the flowcharts in FIGS. 4-6. Execution of the processes shown in the flowcharts in FIGS. 4-6 corresponds to execution of a control method of an in-vehicle network system of the present disclosure. FIG. 4 is a flowchart showing an example of processes executed by the high-level ECU 10 and the first to third intermediate-level ECUs 20, 30, 40. The process shown in the flowchart in FIG. 4 is started upon power ON. In the following, an example in which the high-level ECU 10 executes the process shown in the flowchart in FIG. 4 will be described.

In step S100, the high-level ECU 10 executes an initialization process. The initialization process includes, for example, initial hardware setting and checking operation of the storage medium. In step S110, the high-level ECU 10 determines whether or not a wakeup factor for the high-level ECU 10 has occurred. For example, the high-level ECU 10 may determine that the wake-up factor has occurred when: a signal (e.g., trigger signal, switch signal, sensor signal, etc.) indicating that the high-level ECU 10 is to wake-up is input to the high-level ECU 10; the high-level ECU 10 receives the NM message containing the PN request information designating the cluster to which the high-level ECU 10 belongs as the active cluster; or the high-level ECU 10 receives the NM message commanding all of the ECUs to wake up. If it is determined in step S110 that the wake-up factor has not occurred, the high-level ECU 10 proceeds to step S120 and enters into the sleep state. If it is determined that the wakeup factor has occurred, the high-level ECU 10 proceeds to step S130.

In step S130, the high-level ECU 10 executes an activation process. The activation process includes, for example, reading software including an operating system (OS) and a program from the storage and storing the read software in the memory. In step S140, the high-level ECU 10 determines, based on various information such as various sensor signals, switch signals, and signals obtained from another ECU, that the situation requires at least one of: the first to third intermediate-level ECUs 20, 30, 40; the first to third low-level ECUs 50, 60, 70; and the first to third virtual communication nodes 10B, 20B, 20C to activate and operate. When the high-level ECU 10 determines that the situation requires the at least one to activate and operate, the high-level ECU 10 generates and transmits the NM message containing the PN request information that designates the cluster to which the at least one, which may be the ECU and/or the virtual communication node, belongs as the active cluster. The high-level ECU 10 also receives the NM messages transmitted from other ECUs, etc., via the communication buses 12 and 13.

In step S150, the high-level ECU 10 determines whether or not the high-level ECU 10 includes a virtual communication node. As shown in FIG. 2, if the high-level ECU 10 has the first virtual communication node 10B, the determination in S150 results in YES and the high-level ECU 10 proceeds to step S160. On the other hand, if the high-level ECU 10 does not have the virtual communication node, the determination in S150 results in NO and the high-level ECU 10 proceeds to step S170.

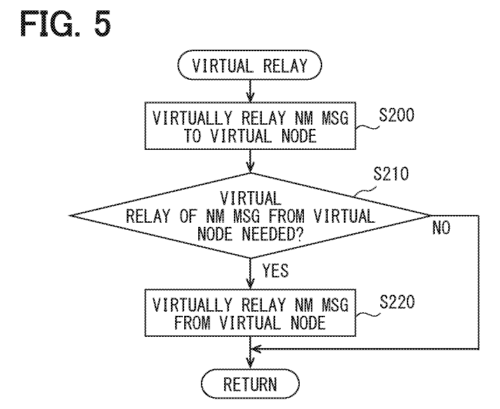

An example of the details of a virtual relay process in step S160 is shown in the flowchart in FIG. 5. The virtual relay process is mainly executed by the first virtual relay 14 of the high-level ECU 10. As shown in the flowchart in FIG. 5, in step S200, the first virtual relay 14 virtually relays the received NM message to the first virtual communication node 10B, i.e., to the first virtual communication node manager 15. In step S210, the first virtual relay 14 determines whether or not it is necessary to virtually relay the NM message from the first virtual communication node 10B. If it is determined that it is necessary to virtually relay the NM message, the first virtual relay 14 proceeds to step S220. On the other hand, if it is determined that it is not necessary to virtually relay the NM message, the first virtual relay 14 ends the process shown in the flowchart in FIG. 5.

If the first low-level ECU 50 is connected to the first relay circuit 17, the first low-level ECU 50 is able to transmit the NM message by itself. Therefore, if the first low-level ECU 50 is connected to the first relay circuit 17, the first virtual relay 14 may determine in step S210, in principle, that it is not necessary to virtually relay the NM message. On the other hand, if: the sensor and/or the actuator not having the communication function is connected to the first relay circuit 17; and it is determined that the situation requires the sensor and/or the actuator to operate, the first virtual communication node manager 15 may transmit the NM message. In this case, the first virtual communication node manager 15 uses the node ID of the virtual communication node 10B to generate the NM message in which the first virtual communication node 10B is the transmission source. If the first virtual communication node manager 15 generates the NM message, the first virtual relay 14 determines in step S210 that it is necessary to virtually relay the NM message from the first virtual communication node 10B.

In step S220, the first virtual relay 14 virtually relays the NM message generated by the first virtual communication node manager 15 to the communication IF 11 of the high-level ECU 10. This allows the NM message generated by the first virtual communication node manager 15 to be transmitted to other ECUs, etc., via the communication IF 11.

The description returns to the flowchart of FIG. 4. In step S170, the high-level ECU 10 determines whether or not a condition for transition to the sleep state is satisfied. For example, when a period of time during which the high-level ECU 10 has not received the NM message from other ECUs reaches a given period of time, the high-level ECU 10 may determine that the condition for transition to the sleep state is satisfied. When it is determined that the condition for transition to the sleep state is satisfied, the high-level ECU 10 proceeds to step S180. On the other hand, if it is determined that the condition for transition to the sleep state is not satisfied, the high-level ECU 10 returns to step S140.

In step 180, the high-level ECU 10 determines whether or not the power is turned off. When it is determined that the power is turned off, the high-level ECU 10 ends the process shown in the flowchart in FIG. 4. When it is determined that the power is not turned off, the high-level ECU 10 returns to step S110.

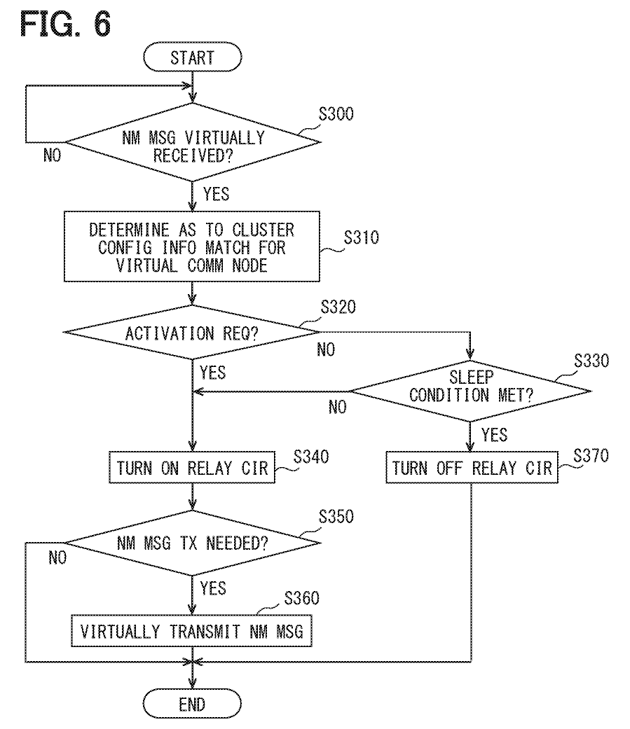

Next, an example of a process executed in the first virtual communication node manager 15 of the high-level ECU 10 will be described with reference to the flowchart in FIG. 6. The process shown in the flowchart in FIG. 6 is also executed in the second and third virtual communication node managers 24 and 25.

First, in step S300, the first virtual communication node manager 15 determines whether or not the virtually relayed NM message has been received virtually. The phrase "virtually received" means that the NM message virtually relayed by the first virtual relay 14 is received by the first virtual communication node manager 15. If it is determined that the virtually relayed NM message has been received virtually, the first virtual communication node manager 15 proceeds to step S310. On the other hand, if it is determined that the virtually relayed NM message has not been received virtually, the first virtual communication node manager 15 repeats step S300 until the NM message is received.

In step S310, the first virtual communication node manager 15 determines whether or not there is a match between the active cluster designated in the PN request information of the virtually received NM message and the cluster of the stored PNC configuration information of the virtual communication node 10B. In step S320, the first virtual communication node manager 15 determines whether or not the virtual communication node 10B is requested to be activated, based on whether or not it has been determined that at one or more clusters, there is the match between the active cluster in the PN request information and the cluster of the stored PNC configuration information. If it is determined that the virtual communication node 10B is not requested to be activated, the first virtual communication node manager 15 proceeds to step S330. On the other hand, if it is determined that the virtual communication node 10B is requested to be activated, the first virtual communication node manager 15 proceeds to step S340.

In step S340, the first virtual communication node manager 15 determines whether or not a sleep condition of the first virtual communication node 10B is satisfied. For example, when a period of time during which the NM message containing the PN request information that designates the cluster to which the first virtual communication node 10B belongs as the active cluster has not been received reaches the given period of time, the first virtual communication node manager 15 may determine that the sleep condition is satisfied. If it is determined that the sleep condition is not satisfied, the first virtual communication node manager 15 proceeds to step S340. On the other hand, if it is determined that the sleep condition is satisfied, the first virtual communication node manager 15 proceeds to step S370.

In step S340, the first virtual communication node manager 15 commands the first relay controller 16 to turn ON the first relay circuit 17. In this way, the first virtual communication node manager 15 can turn ON the first relay circuit 17 upon receipt of the NM message requesting the first virtual communication node 10B to be activated. In step S370, the first virtual communication node manager 15 commands the first relay controller 16 to turn OFF the first relay circuit 17. In this way, the first virtual communication node manager 15 can turn OFF the first relay circuit 17 upon the satisfaction of the sleep condition of the first virtual communication node 10B.

In step S350 executed after turn ON of the first relay circuit 17 in step S340, the first virtual communication node manager 15 determines whether or not it is necessary to transmit the NM message from the first virtual communication node 10B. If it is determined that it is necessary to transmit the NM message, the first virtual communication node manager 15 proceeds to step S360. On the other hand, if it is determined that it is not necessary to transmit the NM message, the first virtual communication node manager 15 ends the process shown in the flowchart in FIG. 6. In step S360, the first virtual communication node manager 15 generates the NM message in which the first virtual communication node 10B is the transmission source and virtually transmits the NM message to the first virtual relay 14.

### SECOND EMBODIMENT

Next, an in-vehicle network system according to a second embodiment will be described. In the in-vehicle network system 100 according to the first embodiment described above, the PNC configuration information assigned to each one of communication nodes such as the first to third intermediate-level ECUs 20, 30, 40, the first to third low-level ECUs 50, 60, 70, and the first to third virtual communication nodes 10B, 20B, 20C, etc., is fixed. However, in cases of, for example, occurrences of function extension of a respective ECU by program updates and/or ECU replacement, addition of an ECU, an sensor and/or an actuator for performing an optional function, and the like, it becomes necessary to make a change in activation timing of the first to third intermediate-level ECU 20, 30, 40, the first to third low-level ECU 50, 60, 70, the first to third virtual communication node 10B, 20B, 20C, etc.

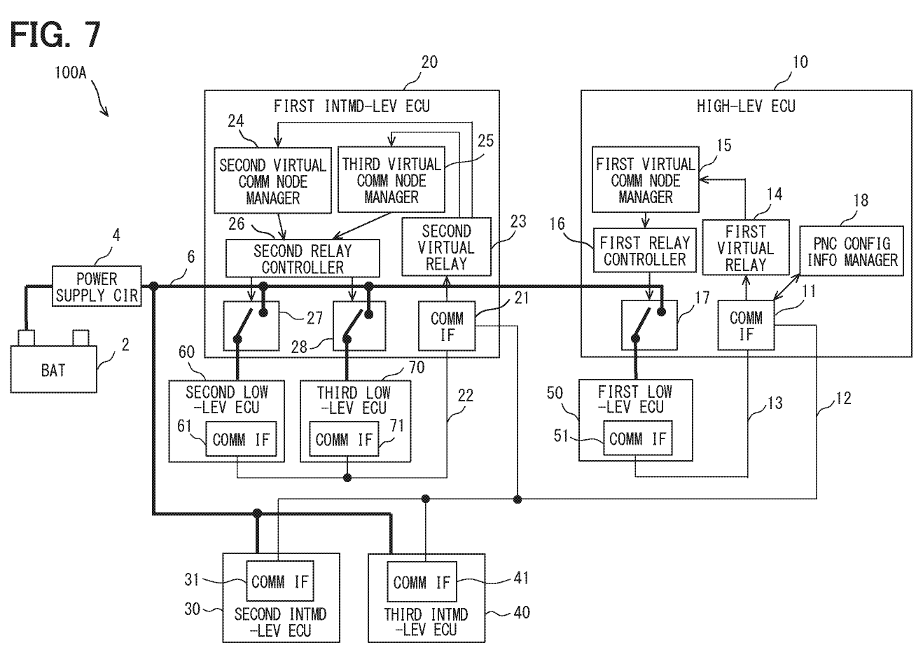

Therefore, the in-vehicle network system of the present embodiment is configured such that the PNC configuration information of a communication node, which may be the first to third intermediate-level ECU 20, 30, 40, the first to third low-level ECU 50, 60, 70, and/or the first to third virtual communication nodes 10B, 20B, 20C, is changeable. An example of the configuration of the in-vehicle network system 100A of the present embodiment is shown in FIG. 7. As shown in FIG. 7, a PNC configuration information manager 18 responsible for managing the PNC configuration information of all of the communication nodes including changing the PNC configuration information of all of the communication nodes is provided in the high-level ECU 10. The PNC configuration information manager 18 corresponds to a cluster configuration information manager of the present disclosure. However, the PNC configuration information manager 18 may be provided in an ECU other than the high-level ECU 10 or an external server, as long as the PNC configuration information manager 18 is communicable with each ECU in the in-vehicle network system 100A. The configuration other than the PNC configuration information manager 18 is the same as that of the in-vehicle network system 100 of the first embodiment unless otherwise described, so the redundant description is omitted.

The PNC configuration information manager 18 is connected to the in-vehicle network and manages all of the communication nodes having the PNC configuration information by linking each communication node to its respective PNC configuration information. For example, for each of the communication nodes such as the first to third intermediate-level ECUs 20, 30, 40, the first to third low-level ECUs 50, 60, 70, and the first to third virtual communication nodes 10B, 20B, 20C, etc., the PNC configuration information manager 18 stores respective PNC configuration information by linking the respective PNC configuration information to a corresponding respective communication node. Therefore, the PNC configuration information manager 18 is able to determine whether or not the PNC configuration information stored in a respective communication node is appropriate by, for example, acquiring the PNC configuration information from the respective communication node and comparing the acquired PNC configuration information with the stored PNC configuration information linked to the respective communication node.

The PNC configuration information manager 18 also has a function of changing the PNC configuration information of all of the communication nodes connected to the in-vehicle network and having the PNC configuration information. Changing the PNC configuration information can be rephrased as configuring (reconfiguring, setting again) the PNC configuration information and updating the PNC configuration information. For example, when addition or replacement of an ECU, addition of an application in any ECU, etc., necessitates a change in an activation condition of at least one ECU, etc., the PNC configuration information manager 18 acquires new PNC configuration information supporting a new activation condition from an external server or other devices via wired or wireless communication. Then, the PNC configuration information manager 18 updates the PNC configuration information of all of the communication nodes having the PNC configuration information based on the acquired PNC configuration information. In this case, the PNC configuration information manager 18 may update only the PNC configuration information of the communication node for which the update (change) of the PNC configuration information is present.

For example, assume that: a vehicle includes a camera and the camera has been used for an advanced driver assistance function such as lane keep assist and obstacle detection during vehicle traveling; and from an external server, the user of the vehicle downloads an application for achieving a function of monitoring an area around the vehicle and home using the camera when the vehicle is in the parked state. This requires the camera to operate not only when the vehicle is traveling but also when the vehicle is in the parked state. In this case, the ECU that controls the camera is required to be in the activated state not only when the vehicle is traveling but also when the vehicle is in the parked state. In such cases, for example, the PNC configuration information in which a cluster for a group of ECUs for controlling the camera when the vehicle is in the parked state is added may be prepared in the external server.

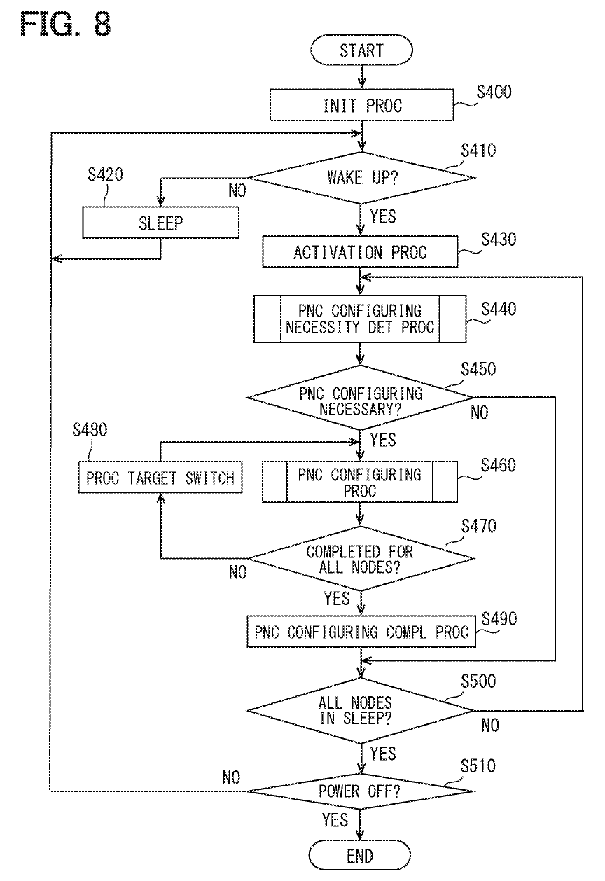

Next, an example of the process executed by the PNC configuration information manager 18 will be described in detail with reference to the flowchart in FIG. 8. The flowchart in FIG. 8 is executed by the PNC configuration information manager 18 implemented in the high-level ECU 10. Upon power on, the high-level ECU 10 starts the process shown in the flowchart in FIG. 8. Steps S400 to S430 in the flowchart in FIG. 8 are the same as S100 to S130 in the flowchart in FIG. 4, so the redundant description is omitted.

In step S440, the PNC configuration information manager 18 executes a PNC configuring necessity determination process of determining whether or not it is necessary to configure (reconfigure) the PNC configuration information of all of the communication nodes. The PNC configuring necessity determination process will be described in detail later.

In step S450, the PNC configuration information manager 18 determines, based on the result of the PNC configuring necessity determination process in step S440, more specifically, based on a value of a PNC configuring flag set in the PNC configuring necessity determination process, whether or not it is necessary to configure (update) the PNC configuration information of all of the communication nodes. If it is determined that it is necessary to configure the PNC configuration information, the PNC configuration information manager 18 proceeds to step S460. On the other hand, if it is determined that it is not necessary to configure the PNC configuration information, the PNC configuration information manager 18 proceeds to step S500.

In step S460, the PNC configuration information manager 18 executes a PNC configuring process of configuring the PNC configuration information for all of the communication nodes. The PNC configuring process will be described in detail later. In step S470, the PNC configuration information manager 18 determines whether or not the PNC configuring process is completed for all of the communication nodes for which it is necessary to configure the PNC configuration information. Specifically, the PNC configuring process is executed one by one for all of the communication nodes in turn. If it is determined that PNC configuring process is not completed for all of the communication nodes, the PNC configuration information manager 18 proceeds to step S480 to switch over and select a process target communication node. Then, in step S160, the PNC configuration information manager 18 executes the PNC configuring process for the selected process target communication node. If it is determined that PNC configuring process is completed for all of the communication nodes, the PNC configuration information manager 18 proceeds to step S490.

In step S490, the PNC configuration information manager 18 executes a PNC configuring completion process because the PNC configuring process is completed for all of the communication nodes. In the PNC configuring completion process, the PNC configuration information manager 18 sets the below-described PNC configuring flag to "0". In step S500, the PNC configuration information manager 18 determines whether or not all of the communication nodes have transitioned to the sleep state. This determination may be made based on whether or not a period of time during which the high-level ECU 10 has not received the NM message from any of the communication nodes reaches a given period of time. If it is determined that all of the communication nodes have transitioned to the sleep state, the PNC configuration information manager 18 proceeds to step S510. On the other hand, if it is determined that not all of the communication nodes have transitioned to the sleep state, the PNC configuration information manager 18 returns to step S440.

In step S510, the PNC configuration information manager 18 determines whether or not the high-level ECU 10 is powered off. If it is determined that the high-level ECU 10 is powered off, the PNC configuration information manager 18 ends the process shown in the flowchart in FIG. 8. On the other hand, if it is determined that the high-level ECU 10 is not powered off, the PNC configuration information manager 18 returns to step S410.

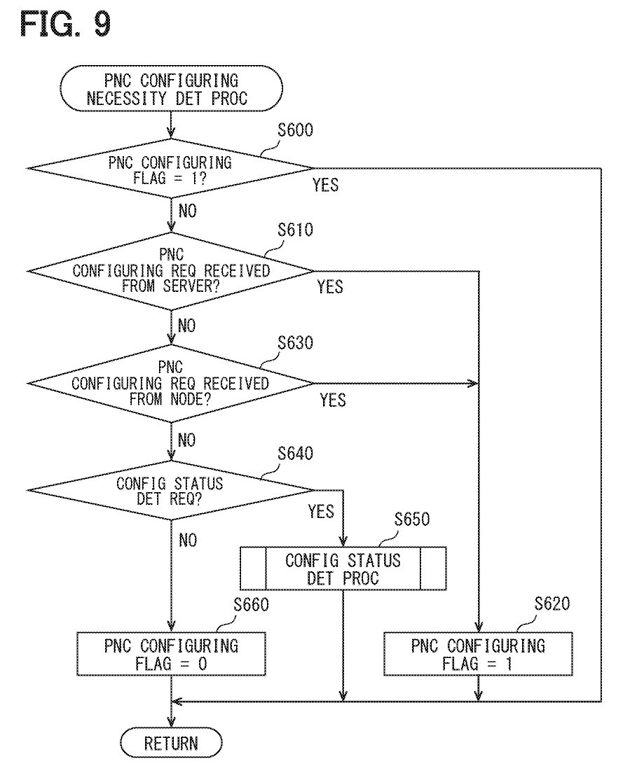

Next, the PNC configuring necessity determination process in step S440 of the flowchart in FIG. 8 will be described in detail. FIG. 9 is a flowchart showing an example of the details of the PNC configuring necessity determination process. The PNC configuring necessity determination process is mainly executed by the PNC configuration information manager 18.

In step S600, the PNC configuration information manager 18 determines whether or not the PNC configuring flag is "1". When it is necessary to reconfigure the PNC configuration information of all of the communication nodes, the below-described step S620 sets the PNC configuration flag to "1". When it is determined in step S600 that the PNC configuring flag is "1", it is highly likely that the PNC configuring process (step S460 in FIG. 8) and/or the PNC configuring completion process (step S490 in FIG. 8) is not normally completed. Therefore, if it is determined that the PNC configuring flag is"1" in step S600, the PNC configuration information manager 18 ends the PNC configuring necessity determination process shown in the flowchart in FIG. 9 without changing the value of the PNC configuring flag in order to execute the PNC configuring process again. On the other hand, if it is determined that the PNC configuring flag is not "1", the PNC configuration information manager 18 proceeds to step S610.

In step S610, the PNC configuration information manager 18 determines whether or not a PNC configuring request has been received from the external server. For example, the external server may transmit the PNC configuring request toward the high-level ECU 10 when the updated PNC configuration information is downloaded to the PNC configuration information manager 18. If it is determined that the PNC configuring request has been received from the external server, the PNC configuration information manager 18 proceeds to step S620 and sets the PNC configuring flag to "1". Thereafter, the PNC configuration information manager 18 ends the PNC configuring necessity determination process shown in the flowchart in FIG. 9. On the other hand, if it is determined that the PNC configuring request has not been received from the external server, the PNC configuration information manager 18 proceeds to step S630.

In step S630, the PNC configuration information manager 18 determines whether or not a PNC configuring request message has been received from at least one communication node. As described in detail later, each communication node is able to determine whether or not the PNC configuration information thereof is appropriate and may transmit the PNC configuring request message to the PNC configuration information manager 18 upon determining that the PNC configuration information is not appropriate. If it is determined that the PNC configuring request message has been received from at least one communication node, the PNC configuration information manager 18 proceeds to step S620 and sets the PNC configuring flag to "1". Thereafter, the PNC configuration information manager 18 ends the PNC configuring necessity determination process shown in the flowchart in FIG. 9. On the other hand, if it is determined that the PNC configuring request message has not been received from any communication node, the PNC configuration information manager 18 proceeds to step S640.

In step S640, the PNC configuration information manager 18 determines whether or not a configuration status determination request has occurred, wherein the configuration status determination request is a request to determine whether or not the PNC configuration information for each communication node retained (stored) by the PNC configuration information manager 18 matches the PNC configuration information in the communication node. Enabling or disabling the configuration status determination in the high-level ECU 10 may be pre-set, for example, by a manufacturer, a seller, or a user of the in-vehicle network system 100A. When the configuration status determination is enabled, the PNC configuration information manager 18 may determine periodically or in given timing that the configuration status determination request has occurred.

If it is determined in step S640 that the configuration status determination request has occurred, the PNC configuration information manager 18 proceeds to step S650 and executes the configuration status determination process. Thereafter, the PNC configuration information manager 18 ends the PNC configuring necessity determination process shown in the flowchart in FIG. 9. The configuration status determination process will be described in detail later. On the other hand, if it is determined in step S640 that the configuration status determination request has not occurred, the PNC configuration information manager 18 proceeds to step S660. In step S660, the PNC configuration information manager 18 sets the PNC configuring flag to "0" because it is not necessary to reconfigure the PNC configuration information. Thereafter, the PNC configuration information manager 18 ends the PNC configuring necessity determination process shown in the flowchart in FIG. 9.

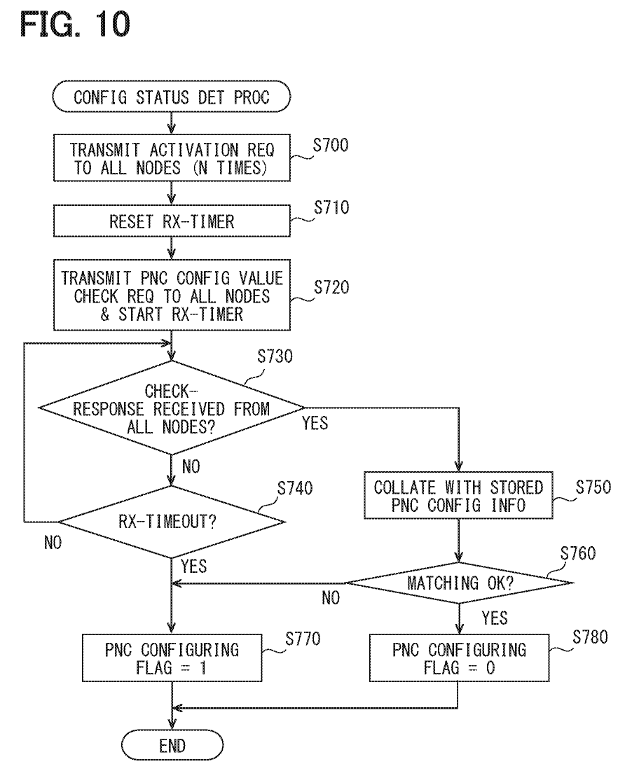

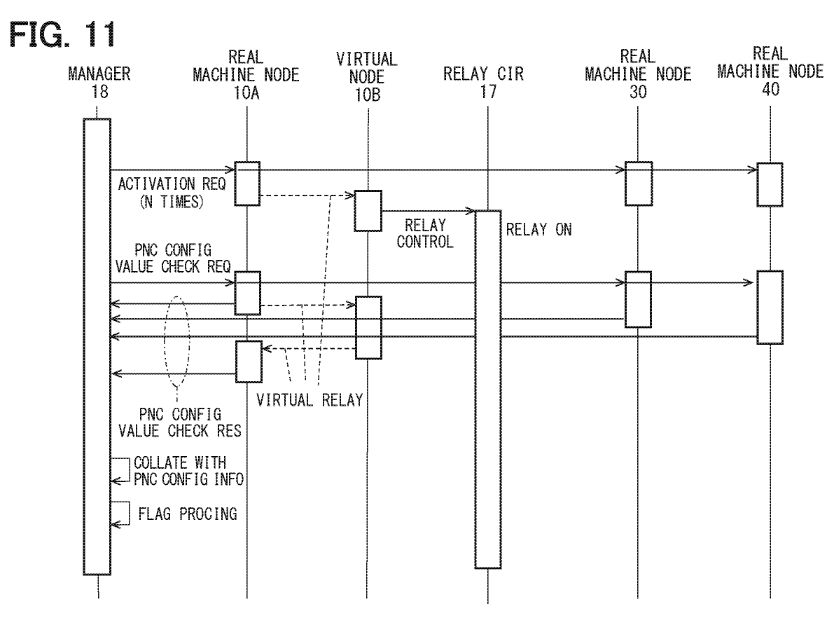

Next, the configuration status determination process in step S650 of the flowchart in FIG. 9 will be described in detail. FIG. 10 is a flowchart showing an example of details of the configuration status determination process. FIG. 11 is a sequence diagram showing an example of a flow of processes at execution of the configuration status determination process, wherein the flow of processes includes processes by the PNC configuration information manager 18 and the real machine communication node and the virtual communication nodes in the high-level ECU 10. The configuration status determination process is mainly performed by the PNC configuration information manager 18. In FIG. 11, the real machine communication node 20A, and the second virtual communication node 20B and the third virtual communication node 20C in the first intermediate-level ECU 20 are omitted from the drawing to simplify the drawing.

In the configuration status determination process, in step S700, the PNC configuration information manager 18 transmits the NM message as the activation request N times (N is an integer of 2 or more), as shown in the sequence diagram in FIG. 11, wherein the NM message is the NM message for placing all of the communication nodes into the activated state. For example, the NM message for placing all of the communication nodes into the activated state transmitted from the PNC configuration information manager 18 may be the NM message containing the PN request information that designates the clusters to which all of the communication nodes belong as the active clusters. Alternatively, the PNC configuration information manager 18 may transmit the NM message commanding the activation to all of the communication nodes. By transmitting the above NM message multiple times, it is possible for the PNC configuration information manager 18 to reliably activate all of the communication nodes.

The NM message for activating all of the communication nodes transmitted from the PNC configuration information manager 18 is virtually relayed to the first virtual communication node 10B (the first virtual communication node manager 15) by the first virtual relay 14, as shown in FIG. 11. As a result, by the NM message for activating all of the communication nodes, the first virtual communication node 10B is activated. In response to activation of the first virtual communication node 10B, the first virtual communication node manager 15 turns ON the relay circuit 17 via the first relay controller 16.

In step S710, the PNC configuration information manager 18 resets a receipt timer. This receipt timer is provided for measuring (counting) the time elapsed since transmission of the message containing a PNC configuration information check request command from the PNC configuration information manager 18. Then, in step S720, the PNC configuration information manager 18 transmits the message containing the PNC configuration information check request command to all of the communication nodes, as shown in the sequence diagram in FIG. 11. At the same time, the PNC configuration information manager 18 starts time measurement (counting) by the receipt timer. The message containing the PNC configuration information check request command may be transmitted by using the node IDs of the respective communication nodes to indicate the transmission destinations. The PNC configuration information check request command may be also referred to as a PNC configuration value check request command. As shown in FIG. 11, the first virtual relay 14 virtually relays the message containing the PNC configuration value check request command and the node ID of the first virtual communication node 10B indicating the transmission destination to the first virtual communication node 10B (first virtual communication node manager 15). The PNC configuration information check request command corresponds to one of management commands in the present disclosure.

In step S730, the PNC configuration information manager 18 determines whether or not a PNC configuration information check responses have been received from all of the communication nodes. The PNC configuration information check response includes a node ID indicating a transmission source and the PNC configuration information in a respective communication node being the transmission source. In response to receiving the message containing the PNC configuration value check request command, the first virtual communication node 10B (first virtual communication node manager 15) also transmits the PNC configuration information check response message containing the node ID and the PNC configuration information. The PNC configuration information check response message transmitted by the first virtual communication node 10B is virtually relayed by the first virtual relay 14 and received by the PNC configuration information manager 18, as shown in FIG. 11.

If the PNC configuration information manager 18 determines in step S730 that the PNC configuration information manager 18 has received the PNC configuration information check response message from all of the communication nodes including the virtual communication nodes, the PNC configuration information manager 18 proceeds to step S750. On the other hand, if it is determined that the PNC configuration information check response message has not yet been received from all of the communication nodes, the PNC configuration information manager 18 proceeds to step S740. In step S740, the PNC configuration information manager 18 determines whether or not a receipt timeout time has elapsed based on the time measured by the receipt timer. If it is determined that the receipt timeout time has elapsed, the PNC configuration information manager 18 proceeds to step S770. On the other hand, if it is determined that the receipt timeout time has not elapsed, the PNC configuration information manager 18 returns to step S730.

When all of the communication nodes are normally activated by the activation request (NM message) transmitted N times from the PNC configuration information manager 18 and are mutually communicable with the PNC configuration information manager 18, the PNC configuration information check response message containing the node ID and the PNC configuration information is expected to be transmitted from all of the communication nodes within a given period of time from when the message containing the PNC configuration information check request command is transmitted from the PNC configuration information manager 18. In other words, if the receipt of the PNC configuration information check response message from a communication node is absent at a time when the time measured by the receipt timer reaches the given period of time (corresponding to the receipt timeout time) after the transmission of the message containing the PNC configuration information check request command by the PNC configuration information manager 18, there is a possibility that the communication node may have an abnormality in the PNC configuration information and failed to normally activate. Therefore, in step S770, the PNC configuration information manager 18 sets the PNC configuring flag to "1" in order to reconfigure the PNC configuration information for all of the communication nodes.

In step S750, for each communication node, the PNC configuration information manager 18 collates the PNC configuration information included in the PNC configuration information check response message received from a respective communication node with the PNC configuration information for the respective communication node stored in the PNC configuration information manager 18. Then, in step S760, the PNC configuration information manager 18 determines whether or not the matching is successful (matching is OK) based on a result of the collation in S750. At this time, the PNC configuration information manager 18 determines that the matching is OK if the complete match of the PNC configuration information is found for all of the communication nodes. On the other hand, the PNC configuration information manager 18 determines that the matching is NG (matching is unsuccessful) if an un-match of the PNC configuration information is found for at least one communication node.

If the unsuccessful matching is determined in step S760, the PNC configuration information manager 18 proceeds to step S770 and sets the PNC configuring flag to "1" in order to reconfigure the PNC configuration information for all of the communication nodes. On the other hand, if the successful matching is determined, the PNC configuration information manager 18 proceeds to step S780 and sets the PNC configuring flag to "0" because it is unnecessary to reconfigure the PNC configuration information.

The configuration status determination process described above makes it possible to update the PNC configuration information retained in each communication node so that the updated PNC configuration information matches the PNC configuration information stored in the PNC configuration information manager 18, even if the PNC configuration information retained in each communication node has somehow become inconsistent with the PNC configuration information for each communication node stored in the PNC configuration information manager 18. Because of this, it is possible to maintain the PNC configuration information of each communication node appropriately.

In the above example, the PNC configuration information manager 18 transmits the message containing the PNC configuration information check request command to all of the communication nodes at the same time. However, in a given order for individual communication nodes, the PNC configuration information manager 18 may perform, in turn, transmitting the message containing the PNC configuration information check request command and receiving the PNC configuration information check response message.

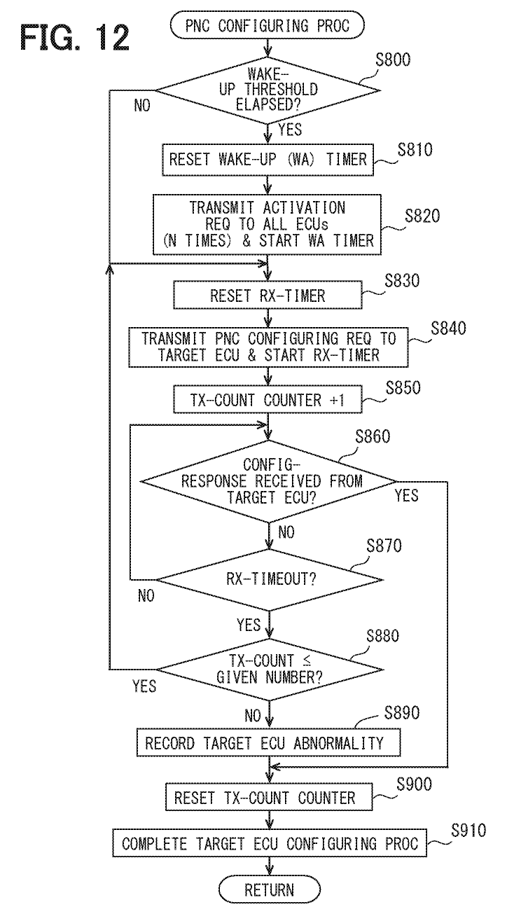

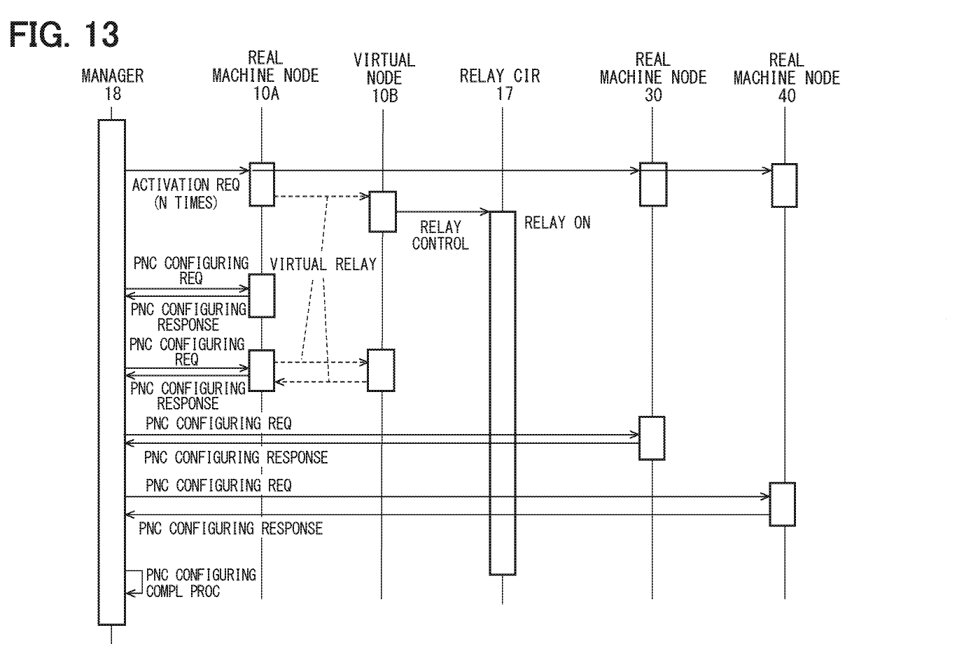

Next, the PNC configuring process in step S460 of the flowchart in FIG. 8 will be described in detail. FIG. 12 is a flowchart showing an example of the details of the PNC configuring process. FIG. 13 is a sequence diagram showing an example of the flow of processes at execution of the PNC configuring process, the flow including processes by the PNC configuration information manager 18 and the real machine communication node and the virtual communication node of the high-level ECU 10. The PNC configuring process is mainly executed by the PNC configuration information manager 18 implemented in the high-level ECU 10. For simplifying the drawing, the real machine communication node 20A, and the second virtual communication node 20B and the third virtual communication node 20C in the first intermediate-level ECU 20 are omitted from FIG. 13.

In a given order, the PNC configuring process is executed in turn for all communication nodes. Therefore, for the PNC configuring process, a respective communication node needs to keep the activated state until the respective communication node’s turn comes. Therefore, in step S800, the PNC configuration information manager 18 determines based on a time measured by a wake-up (WA) timer whether or not a given wake-up threshold time has elapsed since the last N-times (N is an integer greater than or equal to 2 ) transmission of the NM message for activating all of the communication node. This WA timer counts (measures) the time elapsed since the PNC configuration information manager 18 transmitted the NM message (activation request) for activating all of the communication nodes. When it is determined that the given wake-up threshold time has elapsed, the PNC configuration information manager 18 proceeds to step S810. On the other hand, if it is determined that the given wake-up threshold time has not elapsed, the PNC configuration information manager 18 proceeds to step S830.

In step S810, the PNC configuration information manager 18 resets the WA timer. Then, in step S820, the PNC configuration information manager 18 perform the N-times transmission of the NM message (activation request) for activating all of the communication nodes. At the same time, the PNC configuration information manager 18 starts time measurement by the WA timer. In the sequence diagram in FIG. 13, the N-times transmission of the NM message (activation request) for the second time and later is omitted from the drawing for simplifying the drawing.

A respective communication node transitions to the sleep state when a given sleep threshold time is reached by a period of time during which the respective communication node has not received the NM message containing the PN request information that designates the cluster to which the respective communication node belongs as the active cluster. The given wake-up threshold time is configured as being shorter than the given sleep threshold time of each communication node. Therefore, before the sleep threshold time has elapsed, the PNC configuration information manager 18 can transmit the NM message (activation request) to all of the communication node as the wakeup threshold time elapses. As a result, for the PNC configuring process, a respective communication node can keep the activated state until the respective communication node’s turn comes.

In step S830, the PNC configuration information manager 18 resets the receipt timer. This receipt timer is provided for measuring the time elapsed since the PNC configuring request command was transmitted from the PNC configuration information manager 18. Then, as shown in the sequence diagram in FIG. 13, in step S840, the PNC configuration information manager 18 transmits a message containing a PNC configuring request command to the communication node (target ECU) that is the target of the PNC configuring process, by using the node ID to indicate the transmission destination. The communication node being the target of the PNC configuring process may be the virtual communication node. The message containing the PNC configuring request command contains the updated PNC configuration information linked to the communication node being the target of the PNC configuring process. The PNC configuring request command corresponds to one of management commands in the present disclosure. At the same time, the PNC configuration information manager 18 starts time measurement by the receipt timer.

In step S850, the PNC configuration information manager 18 increments by one a transmission count counter, which counts the number of times the message containing the PNC configuring request command is transmitted. In step S860, the PNC configuration information manager 18 determines whether or not a PNC configuring response message has been received from the communication node being the target of the PNC configuring process. When the communication node being the target of the PNC configuring process receives the message containing the PNC configuring request command from the PNC configuration information manager 18 and stores the PNC configuration information in the volatile memory thereof, the communication node being the target of the PNC configuring process transmits the PNC configuring response message. The PNC configuring response message contains the node ID of the communication node being the target of the PNC configuring process as information indicating the transmission source. This allows the PNC configuration information manager 18 to determine whether or not the PNC configuration response message has been received from the communication node being the target of the PNC configuring process. If the PNC configuration information manager 18 determines that the PNC configuring response message has been received from the communication node being the target of the PNC configuring process, the PNC configuration information manager 18 proceeds to step S900. On the other hand, if it is determined that the PNC configuring response message has not been received from the communication node being the target of the PNC configuring process, the PNC configuration information manager 18 proceeds to step S870.

In step S870, the PNC configuration information manager 18 determines whether or not the receipt timeout time has elapsed based on the time measured by the receipt timer. If it is determined that the reception timeout time has elapsed, the PNC configuration information manager 18 proceeds to step S880. On the other hand, if it is determined that the reception timeout time has not yet elapsed, the PNC configuration information manager 18 returns to step S860. This allows the PNC configuration information manager 18 to proceed with the PNC configuring process even in cases where the PNC configuration information manager 18 fails to receive the PNC configuration response message from the communication node being the target of the PNC configuring process for some events.

In step S880, the PNC configuration information manager 18 determines whether or not the number of times the message containing the PNC configuring request command has been transmitted is less than a given number based on the value of the transmission count counter. The given number is determinable as any number greater than or equal to 2. If it is determined that the number of times the message containing the PNC configuring request command has been transmitted is still less than or equal to the given number, the PNC configuration information manager 18 returns to step S830 to repeat the transmission of the message containing the PNC configuring request command. On the other hand, if it is determined that the number of times the message containing the PNC configuring request command has been transmitted exceeds the given number, the PNC configuration information manager 18 proceeds to step S890. Thus, because the PNC configuration information manager 18 transmits the message containing the PNC configuring request command multiple times by the repeated transmission, it is possible to increase a probability that the communication node being the target of the PNC configuring process receives the message containing the PNC configuring request command.

In step S890, the PNC configuration information manager 18 records a PNC configuring abnormality of the communication node being the target of the PNC configuring process in the nonvolatile storage medium because receipt of the PNC configuring response message from the communication node being the target of the PNC configuring process is unsuccessful despite the multiple transmissions (repeatedly transmitting) of the message containing the PNC configuring request command.

In step S900, the PNC configuration information manager 18 resets the transmission count counter in preparation for the PNC configuring process for the communication node being the next target of the PNC configuring process. Then, in step S910, the PNC configuration information manager 18 determines the completion of the PNC configuring process for the communication node being the target of the PNC configuring process and returns to the flowchart in FIG. 8. The PNC configuring process shown in the flowchart in FIG. 8 is repeatedly executed until the PNC configuring process is completed for all of the communication nodes including the virtual communication nodes.

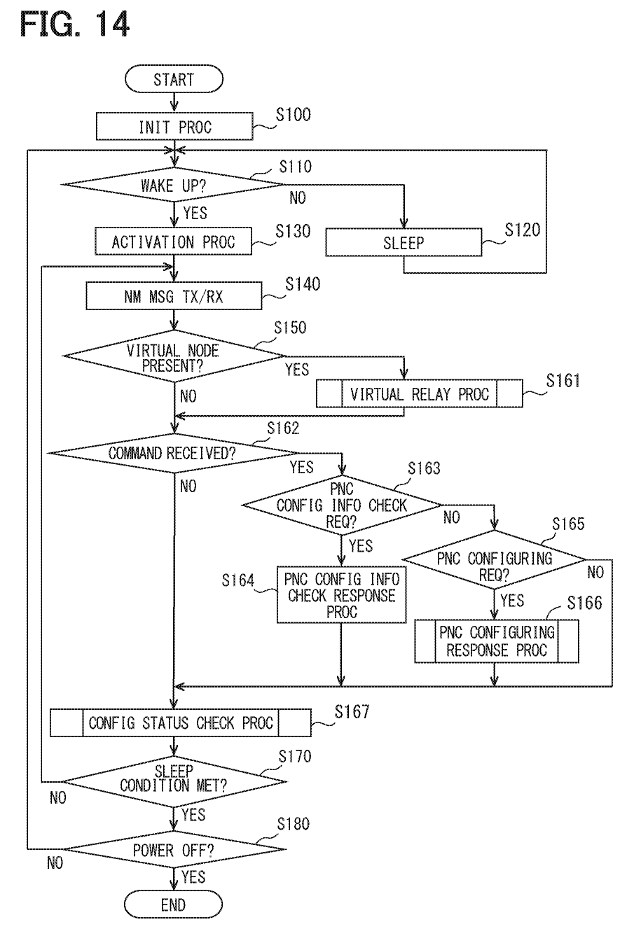

Next, an example of the processes performed by the high-level ECU 10 and the first to third intermediate-level ECUs 20, 30, 40 in the in-vehicle network system 100A will be described with reference to the flowchart in FIG. 14. In the following, an example in which the high-level ECU 10 executes the process shown in the flowchart in FIG. 14 will be described. Steps S100 to S150 and steps S170 to S180 in the flowchart in FIG. 14 are the same as steps S100 to S150 and steps S170 to S180 in the flowchart in FIG. 4, so the redundant description is omitted.

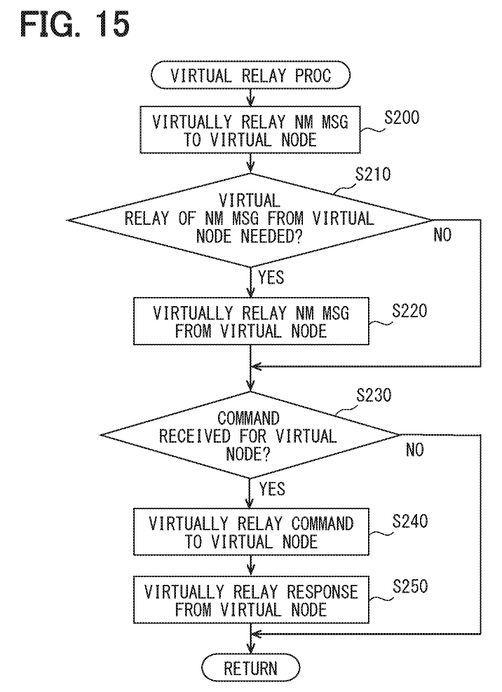

In step S161, the high-level ECU 10 executes the virtual relay process. An example of details of the virtual relay process in step S161 is shown in the flowchart in FIG. 15. The virtual relay process is mainly executed by the first virtual relay 14 of the high-level ECU 10. Steps S200 to S220 in the flowchart in FIG. 15 are the same as steps S200 to S220 in the flowchart in FIG. 5, so the redundant description is omitted.

In step S230, the first virtual relay 14 determines whether or not the first virtual relay 14 has received a message containing a command destined for the first virtual communication node 10B based on the node ID indicating the destination contained in the message containing the command transmitted from the PNC configuration information manager 18. The command may be the PNC configuration information check request command, the PNC configuring request command, etc. If it is determined that the message containing the command destined for the first virtual communication node 10B has been received, the first virtual relay 14 proceeds to step S240. On the other hand, if it is determined that the message containing the command destined for the first virtual communication node 10B has not been received, the first virtual relay 14 ends the process shown in the flowchart in FIG. 15.

In step S240, the first virtual relay 14 virtually relays the received message containing the command to the first virtual communication node 10B. In step S250, the first virtual relay 14 virtually relays a response message from the first virtual communication node 10B being a response to the command. The response message from the first virtual communication node 10B is then transmitted to the PNC configuration information manager 18.

The description returns to the flowchart of FIG. 14. In step S162 of the flowchart in FIG. 14, the high-level ECU 10 determines whether or not the high-level ECU 10 has received the message containing the command destined for the real machine communication node 10A of the high-level ECU 10 based on the node ID indicating the destination included in the message transmitted from the PNC configuration information manager 18. If it is determined that the message containing the command destined for real machine communication node 10A has been received, the high-level ECU 10 proceeds to step S163. On the other hand, if it is determined that the message containing the command destined for the real machine communication node 10A has not been received, the high-level ECU 10 proceeds to step S167.

In step S163, the high-level ECU 10 determines whether or not the command in the received message is the PNC configuration information check request command. If it is determined that the command is the PNC configuration information check request command, the high-level ECU 10 proceeds to step S164. On the other hand, if it is determined that the command is not the PNC configuration information check request command, the high-level ECU 10 proceeds to step S165.

In step S164, the high-level ECU 10 executes the PNC configuration information check response process. Specifically, the high-level ECU 10 generates a PNC configuration information check response message containing the PNC configuration information configured for the high-level ECU 10 and transmits the generated message to the PNC configuration information manager 18. Thereafter, the high-level ECU 10 proceeds to S167.

In step S165, the high-level ECU 10 determines whether or not the command in the received message is the PNC configuring request command. If it is determined that the command is the PNC configuring request command, the high-level ECU 10 proceeds to step S166. On the other hand, if it is determined that it the command is not the PNC configuring request command, the high-level ECU 10 proceeds to step S167. In step S166, the high-level ECU 10 executes the PNC configuring response process. The PNC configuring response process will be described in detail later. Then, the high-level ECU 10 proceeds to S167.

In step S167, the high-level ECU 10 executes a configuration status check process of checking whether or not the PNC configuration information configured for the high-level ECU 10 is appropriate. This configuration status check process will be described in detail later. The configuration status check process may be performed after the change in the PNC configuration information by the PNC configuration information manager 18. Alternatively, the configuration status check process may be performed in response to the determination that the condition for transition to the sleep state is satisfied in step S170.

In each of the first to third low-level ECUs 50, 60, 70, the process shown in the flowchart in FIG. 14 except steps S150 and S161 is executed to check the PNC configuration information and update the PNC configuration information.

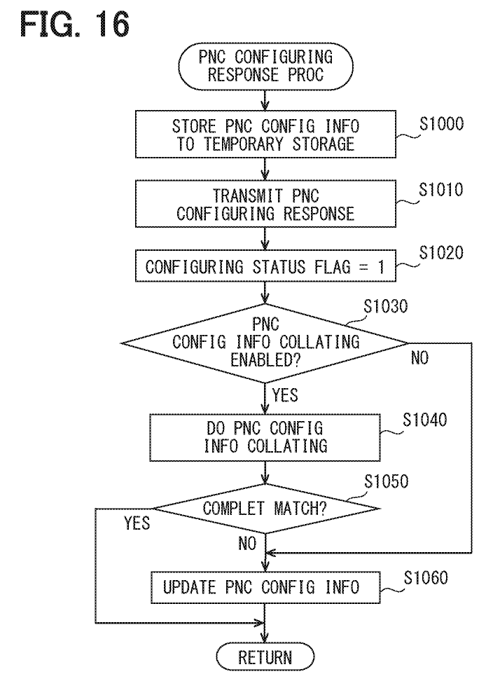

Next, the PNC configuring response process in step S166 of the flowchart in FIG. 14 will be described in detail. FIG. 16 is a flowchart showing an example of the details of the PNC configuring response process. In the following, an example in which the high-level ECU 10 executes the process shown in the flowchart in FIG. 16 will be described.

In step S1000, the high-level ECU 10 stores the PNC configuration information contained in the PNC configuring request command of the received message in the volatile memory being a temporary storage. In step S1010, the high-level ECU 10 transmits the PNC configuring response message containing the node ID indicating the transmission source toward the PNC configuration information manager 18. In step S1020, the high-level ECU 10 sets a value of a configuring status flag to "1". The value "1" of the configuring status flag means that the receipt of the updated PNC configuration information is completed and that the change in the PNC configuration information is ready to be executed. The high-level ECU 10 sets the configuring status flag to "0" upon, for example, receiving the PNC configuring request command.

In step S1030, the high-level ECU 10 determines whether or not PNC configuration information collating is enabled. Enabling and disabling the PNC configuration information collating may be pre-set by, for example, a manufacturer, a seller, or a user of the in-vehicle network system 100A. If it is determined that the PNC configuration information collating is enabled, the high-level ECU 10 proceeds to step S1040. On the other hand, if it is determined that the PNC configuration information collating is disabled, the high-level ECU 10 proceeds to step S1060.

In step S1040, the high-level ECU 10 executes the collating to check whether or not the PNC configuration information stored in the volatile memory being the temporary storage completely matches the current PNC configuration information stored in the non-volatile memory. Then, in step S1050, the high-level ECU 10 determines whether or not the result of the collation is a complete match between both the PNC configuration information. If the complete match is determined, the high-level ECU 10 ends the PNC configuring response process shown in the flowchart in FIG. 16. In the case of the complete match, the high-level ECU 10 does not execute the process of updating the PNC configuration information by writing the PNC configuration information stored in the volatile memory into the non-volatile memory. This can reduce the number of rewrites of the non-volatile memory 26. On the other hand, if it is determined that the check result is not the complete match, the high-level ECU 10 proceeds to step S1060.

In step S1060, the high-level ECU 10 writes (e.g., by overwriting) the PNC configuration information temporarily stored in the volatile memory into the nonvolatile memory. The high-level ECU 10 then ends the PNC response process shown in the flowchart in FIG. 16.

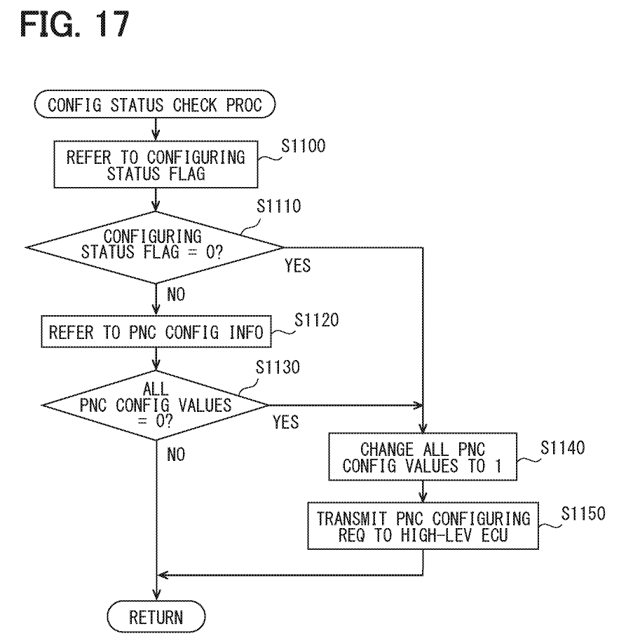

Next, the configuration status check process in step S167 of the flowchart in FIG. 14 will be described in detail. FIG. 17 is a flowchart showing an example of the details of the configuration status check process. In the following, an example in which the high-level ECU 10 executes the process shown in the flowchart in FIG. 17 will be described.

In step S1100, the high-level ECU 10 refers to the value of the configuring status flag. Then, in step S1110, the high-level ECU 10 determines whether or not the value of the configuring status flag is "0". As described above, the high-level ECU 10 sets the configuring status flag to "1" upon completing the receipt of the updated PNC configuration information and being ready to execute the change in the PNC configuration information. Therefore, when the value of the configuring status flag is "0", the PNC configuring has not been executed in the high-level ECU 10, and the PNC configuration information in the high-level ECU 10 is considerable as being not appropriate. Therefore, if it is determined that the value of the configuring status flag is "0" in step S1110, the high-level ECU 10 proceeds to step S1140. On the other hand, if it is determined that the value of the configuring status flag is not "0", the high-level ECU 10 proceeds to step S1120.

In step S1120, the high-level ECU 10 refers to the PNC configuration information configured for the high-level ECU 10. Then, in step S1130, the high-level ECU 10 determines whether or not all of the PNC configuration values contained in the PNC configuration information are "0". When all of the PNC configuration values are "0", this indicates that the high-level ECU 10 does not belong to any cluster. In this case, the NM message containing the PN request information designating the activation cluster is not able to activate the high-level ECU 10. For this reason, the PNC configuration values that are all "0" are considerable as not being appropriate. Therefore, if it is determined that all of the PNC configuration values are "0" in step S1130, the high-level ECU 10 proceeds to step S1140. On the other hand, if it is determined that not all of the PNC configuration values are "0", the high-level ECU 10 ends the configuration status check process shown in the flowchart in FIG. 17 and returns to the process in the flowchart in FIG. 14.

In step S1140, the high-level ECU 10 rewrites all of the PNC configuration values in the PNC configuration information configured for the high-level ECU 10 into "1", for example. In other words, if the high-level ECU 10 determines that the PNC configuration information configured for the high-level ECU 10 is not appropriate, the high-level ECU 10 changes the PNC configuration information so that the high-level ECU belongs to all of the clusters. In this way, the high-level ECU 10 may change the activation condition so that the high-level ECU 10 is activated by any NM message containing the PN request information that designates at least one cluster as the active cluster. This can at least prevent occurrence of a situation where the NM message is not able to activate the high-level ECU 10.

In step S1150, the high-level ECU 10 transmits the PNC configuring request message to the PNC configuration information manager 18. If the high-level ECU 10 changes the activation condition as described above, any NM message may activate the high-level ECU 10. In this case, the high-level ECU 10 may be activated not only when the high-level ECU 10 is supposed to be activated but also in other timing. By transmitting the PNC configuring request message by the high-level ECU 10, the PNC configuration information manager 18 may reconfigure the PNC configuration information of the high-level ECU 10 into the appropriate PNC configuration information. As a result, power consumption due to unnecessary activation of the high-level ECU 10 can be suppressed.

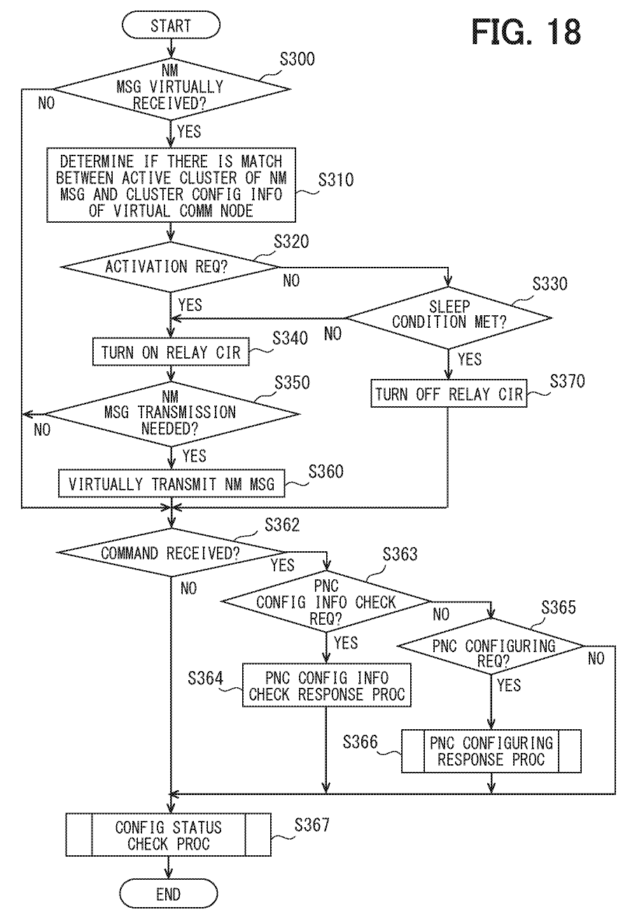

Next, the processes executed in the first to third virtual communication nodes 10B, 20B, 20C will be described with reference to the flowchart in FIG. 18. In the following, an example in which the first virtual communication node manager 15 of the first virtual communication node 10B executes the process shown in the flowchart in FIG. 18 will be described. Steps S300 to S360 in the flowchart in FIG. 18 are the same as steps S300 to S360 in the flowchart in FIG. 6 unless otherwise described, so the redundant description is omitted. In the flowchart in FIG. 18, if the first virtual communication node manager 15 determines in step S300 that the NM message has not been received virtually, the first virtual communication node manager 15 proceeds to step S362.

In S362, the first virtual communication node manager 15 determines whether or not the message containing the command destined for the first virtual communication node 10B has been received based on the node ID indicating the destination contained in the message transmitted from the PNC configuration information manager 18. If it is determined that the message containing the command destined for the first virtual communication node 10B has been received, the first virtual communication node manager 15 proceeds to step S363. On the other hand, if it is determined that the message containing the command destined for the first virtual communication node 10B has not been received, the first virtual communication node manager 15 proceeds to step S367.

In step S363, the first virtual communication node manager 15 determines whether or not the command in the received message is the PNC configuration information check request command. If it is determined that the command is the PNC configuration information check request command, the first virtual communication node manager 15 proceeds to step S364. On the other hand, if it is determined that the command is not the PNC configuration information check request command, the first virtual communication node manager 15 proceeds to step S365.

In step S364, the first virtual communication node manager 15 executes the PNC configuration information check response process. Specifically, the first virtual communication node manager 15 generates the PNC configuration information check response message containing the PNC configuration information configured for the first virtual communication node manager 15 and transmits the generated message to the PNC configuration information manager 18. The first virtual communication node manager 15 then proceeds to step S367.

In step S365, the first virtual communication node manager 15 determines whether or not the command in the received message is the PNC configuring request command. If it is determined that the command is the PNC configuring request command, the first virtual communication node manager 15 proceeds to step S366. On the other hand, if it is determined that the command is not the PNC configuring request command, the first virtual communication node manager 15 proceeds to step S367. In step S366, the first virtual communication node manager 15 executes the PNC configuring response process. The PNC configuring response process is the same as the PNC configuring response process described with reference to the flowchart in FIG. 16, so the redundant description is omitted. The first virtual communication node manager 15 then proceeds to step S367.

In step S367, the first virtual communication node manager 15 executes the configuration status check process of checking whether or not the PNC configuration information configured for the first virtual communication node manager 15 is appropriate. This configuration status check process is the same as the configuration status check process described with reference to the flowchart in FIG. 17, so the redundant description is omitted. The first virtual communication node manager 15 then ends the process shown in the flowchart in FIG. 18.

### MODIFICATIONS

The systems and methods described in the present disclosure may be implemented by a special purpose computer comprising a processor programmed to perform one or more functions embodied in a computer program. The systems and methods described in the present disclosure may be implemented using a dedicated hardware logic circuit. The systems and methods described in the present disclosure may be implemented by one or more special purpose computers comprising a combination of a processor executing a computer program and one or more hardware logic circuits. For example, part or all of the functions provided by the high-level ECU 10 and the first to third intermediate-level ECUs 20, 30, 40 may be implemented by hardware. A form in which a certain function is implemented by a hardware logic circuit encompasses a form in which the function is implemented using one or more ICs or the like. Part or all of the functions provided by the high-level ECU 10 and the first to third intermediate-level ECUs 20, 30, 40 may be implemented using any of a system-on-chip (SoC), integrated circuit (IC), and field-programmable gate array (FPGA). The term “IC” encompasses ASIC (Application Specific Integrated Circuits). The computer program may be stored in a computer-readable non-transitory tangible storage medium as instructions to be executed by a computer. Examples of the storage medium storing the computer program include a hard disk drive (i.e., HDD), a solid-state drive (i.e., SSD), a flash memory, and the like. Programs causing computers to function as the high-level ECU 10 and the first to third intermediate-level ECU 20, 30, 40 and the non-transitory tangible storage medium, e.g., semiconductor memory, storing the program are also within the present disclosure.

What is claimed is:

1. An in-vehicle network system comprising a plurality of control devices communicable with each other via a communication bus in a vehicle, wherein:
the plurality of control devices is each implemented at least by a processor that executes a program and/or a dedicated hardware circuit;
the plurality of control devices includes a high-level side control device being at least one high-level side control device;
the high-level side control device controls supply and non-supply of power to a target device being at least one target device; and
the high-level side control device includes:
a relay controller that turns ON or OFF a relay circuit provided in a power supply line for the target device;
a virtual communication node manager that manages a virtual communication node corresponding to the relay circuit; and
a virtual relay that virtually relays a network management message to the virtual communication node manager when the high-level side control device receives the network management message,
wherein the virtual communication node manager commands the relay controller to turn ON the relay circuit when the received network management message commands the virtual communication node to activate.

2. The in-vehicle network system according to claim 1, wherein:
the virtual communication node manager stores cluster configuration information thereof indicating a cluster to which the virtual communication node belongs;
the network management message contains active cluster information designating an active cluster being a cluster to be active; and
when the active cluster designated in the network management message matches the cluster in the cluster configuration information of the virtual communication node, the virtual communication node manager considers that the virtual communication node is commanded to activate by the network management message.

3. The in-vehicle network system according to claim 2, wherein:
the at least one target device includes one target device that is connected to the relay circuit;
there is provided cluster configuration information of the one target device indicating the cluster to which the one target device belongs; and
the cluster configuration information of the virtual communication node includes the cluster configuration information of the one target device.

4. The in-vehicle network system according to claim 2, wherein:
the at least one target device includes a first target device and a second target device that are connected to the relay circuit;
there is provided first cluster configuration information of the first target device indicating the cluster to which the first target device belongs;
there is provided second cluster configuration information of the second target device indicating the cluster to which the second target device belongs; and
the cluster configuration information of the virtual communication node includes cluster configuration information corresponding to logical OR of the first cluster configuration information of the first target device and the second cluster configuration information of the second target device.

5. The in-vehicle network system according to claim 2, wherein:
the high-level side control device serves as a communication node and has a first node identifier unique to distinguish from other communication nodes;
the virtual communication node manager has a second node identifier of the virtual communication node different from the first node identifier of the high-level side control device; and
by using the second node identifier, the virtual communication node manager receives a message destined for the virtual communication node and/or transmits a message from the virtual communication node.

6. The in-vehicle network system according to claim 5, further comprising:
a cluster configuration information manager that is implemented in any of the plurality of control devices and that manages at least the cluster configuration information of the virtual communication node, wherein:
by using the second node identifier, the cluster configuration information manager transmits and receives a management command to and from the virtual communication node manager to manage the cluster configuration information stored in the virtual communication node manager.

7. The in-vehicle network system according to claim 6, wherein:
by using the second node identifier, the cluster configuration information manager transmits a message destined for the virtual communication node and containing the management command that requests transmission of the cluster configuration information of the virtual communication node;
to the virtual communication node, the virtual relay virtually relays the message destined for the virtual communication node and containing the management command requesting the transmission of the cluster configuration information; and
in response to the received message destined for the virtual communication node and containing the management command requesting the transmission of the cluster configuration information, the virtual communication node manager transmits, to the cluster configuration information manager, a message containing the cluster configuration information of the stored virtual communication node while indicating a transmission source by the second node identifier.

8. The in-vehicle network system according to claim 6, wherein:
by using the second node identifier, the cluster configuration information manager transmits a message destined for the virtual communication node and containing the cluster configuration information to be stored in the virtual communication node manager and the management command requesting an update of the cluster configuration information;
to the virtual communication node, the virtual relay virtually relays the message destined for virtual communication node and containing the cluster configuration information for the virtual communication node and the management command; and
the virtual communication node manager updates the stored cluster configuration information of the virtual communication node with the received cluster configuration information for the virtual communication node.

9. The in-vehicle network system according to claim 6, wherein:
the virtual communication node manager determines whether or not the stored cluster configuration information of the virtual communication node is abnormal, and upon determining that the stored cluster configuration information is abnormal, the virtual communication node manager transmits, to the cluster configuration information manager, a message indicating a transmission source by the second node identifier and containing the management command requesting reconfiguration of the cluster configuration information of the virtual communication node.

10. A high-level side control device that is used in an in-vehicle network system including a plurality of control devices communicable with each other via a communication bus in a vehicle, wherein:
the plurality of control devices including the high-level side control device is each implemented at least by a processor that executes a program and/or a dedicated hardware circuit; and
the high-level side control device controls supply and non-supply of power to a target device,
the high-level side control device comprising:
a relay controller that turns ON or OFF a relay circuit provided in a power supply line for the target device;
a virtual communication node manager that manages a virtual communication node corresponding to a relay circuit; and
a virtual relay that virtually relays a network management message to the virtual communication node manager when the high-level side control device receives the network management message,
wherein the virtual communication node manager commands the relay controller to turn ON the relay circuit when the received network management message commands the virtual communication node to activate.

11. A program stored in a non-transitory storage medium, the program causing a high-level side control device, which high-level side control device is used in an in-vehicle network system including a plurality of control devices communicable with each other via a communication bus in a vehicle, to execute controlling supply and non-supply of power to a target device,
the program causing the high-level side control device to function as:
a relay controller that turns ON or OFF a relay circuit provided in a power supply line for the target device;
a virtual communication node manager that manages a virtual communication node corresponding to a relay circuit; and
a virtual relay that virtually relays a network management message to the virtual communication node manager when the high-level side control device receives the network management message,
wherein the virtual communication node manager commands the relay controller to turn ON the relay circuit when the received network management message commands the virtual communication node to activate.

12. A control method of an in-vehicle network system including a plurality of control devices communicable with each other via a communication bus in a vehicle,
the plurality of control devices including a high-level side control device that controls supply and non-supply of power to a target device by turning ON and OFF a relay circuit provided in a power supply line for the target device,
the high-level side control device including a virtual communication node manager that manage a virtual communication node corresponding to the relay circuit,
the control method comprising:
virtually relaying a network management message to the virtual communication node manager when the high-level side control device receives the network management message; and
commanding, by the virtual communication node manager, turn ON of the relay circuit when the received network management message commands the virtual communication node to activate.
